(19) United States
(12) Patent Application Publication
(10) Pub. No.: US 2017/0193542 A1
(43) Pub. Date: Jul. 6, 2017

(54) SYSTEM, METHOD, AND NON-TRANSITORY COMPUTER-READABLE STORAGE MEDIA FOR EVALUATING SEARCH RESULTS IN A PRICE COMPARISON SYSTEM

(71) Applicant: Wal-Mart Stores, Inc., Bentonville, AR (US)

(72) Inventors: Venkata Syam Prakash Rapaka, Mountain View, CA (US); Sushant Kumar, Bentonville, AR (US); Arun Kumar Nautiyal, Sunnyvale, CA (US)

(21) Appl. No.: 14/985,981

(22) Filed: Dec. 31, 2015

(51) Int. Cl. G06Q 30/02; G06F 17/30; G06Q 30/06

(52) U.S. Cl. CPC G06Q 30/0226; G06Q 30/0625; G06F 17/3053

(57) ABSTRACT

A system, method and computer product that performs a search request against a database of competitor information as a function of a user's transaction and ranks the user as a function of user historical transactions and the search results.

### FIELD OF THE DISCLOSURE

The present invention relates to search engines, and more particularly, to systems, methods, and computer-readable storage media that perform a search request against a database of competitor information as a function of a user's transaction and ranks the user as a function of user historical transactions and the search results. The suggested class/subclass of the disclosure is: CLASS 707/722 (DATA PROCESSING: DATABASE, DATA MINING, AND FILE MANAGEMENT OR DATA STRUCTURES/Post processing of search results) and the suggested Art Unit is 2161.

### BACKGROUND

For retailers in some instances, it is very important that customers receive the lowest possible price on items for sale and that customers are aware that the prices at the retailer provide the best deal. For customers, it is likewise important to find the best possible deal on purchases. For both the retailer and the customer, it can be difficult to evaluate pricing. Competitors may transmit advertisements on various media, and publish advertisements and coupons in various publications. A customer must therefore wade through all of these for all items in order to find the best deal. Once found, price matching may enable a customer to buy all items at the same store, rather than visit various retail stores. However, the time spent in reviewing advertisements each week is nonetheless inconvenient.

The systems and methods disclosed herein provide an improved approach for a retailer to ensure that prices paid by a customer are competitive and to ensure that the customer is aware of savings obtained by shopping at a retailer.

The present invention is aimed at one or more of the problems identified above.

### SUMMARY OF THE INVENTION

In different embodiments of the present invention, systems, methods, and computer-readable storage media provide incentives to the customers of retailers to use submit transaction, i.e., receipts, to a search engine for price comparison purposes.

In one aspect of the present invention, a system includes a first database, a second database, a search engine module, a credit determination module, a customer scoring module, and a customer ranking module. The first database is used to store system usage information of the system. The system usage information being associated with a plurality of customers of a retailer. The second database is used to store pricing information associated with a plurality of products for a plurality of other retailers. The search engine module receives a search engine search request. The search engine search request includes transaction data associated with one of the customers at the retailer. The transaction data includes a price of a product paid by the one of the customers during a transaction at the retailer. The search engine module performs a search of the second database as a function of the search engine search request and returns pricing information of the product associated with at least one of the other retailers. The credit determination module compares the price paid by the one of the customers and the pricing information of the product associated with at least one of the other retailers. The credit determination module awards the one of the customers a credit if the comparison of the price paid by the one of the customers and the pricing information of the product associated with at least one of the other retailers meets predefined criteria and stores the search engine search request and any awarded credit in the first database as usage information associated with the one of the customers. The customer scoring module analyzes the usage information of the system associated with the plurality of customers and establishes a customer score for each customer as a function of the credit awarded to the respective customer over a plurality of transactions and respective system usage information stored in the first database. The customer ranking module ranks the plurality of customers as a function of the respective customer score.

In another embodiment of the present invention, a method is provided. In a first step, usage information is stored in a first database. The system usage information is associated with a plurality of customers of a retailer. In a second step, pricing information associated with a plurality of products for a plurality of other retailers is stored in a second database. A search engine request is received at a search engine module in a third step. The search engine search request includes transaction data associated with one of the customers at the retailer. The transaction data includes a price of a product paid by the one of the customers during a transaction at the retailer. In a fourth step, the search engine module performs a search of the second database as a function of the search engine search request and returns pricing information of the product associated with at least one of the other retailers. In a fifth step, the price paid by the one of the customers and the pricing information of the product associated with at least one of the other retailers are compared. In a sixth step, the one of the customers is awarded a credit if the comparison of the price paid by the one of the customers and the pricing information of the product associated with at least one of the other retailers meets predefined criteria. The search engine search request and any awarded credit are stored in the first database as usage information associated with the one of the customers. In a seventh step, the usage information of the system associated with the plurality of customers is analyzed and a customer score for each customer is established as a function of the credit awarded to the respective customer over a plurality of transactions and respective system usage information stored in the first database. The customers are ranked as a function of the respective customer score.

In still another embodiment of the present invention, one or more non-transitory computer-readable storage media, having computer-executable instructions embodied thereon, wherein when executed by at least one processor, the computer-executable instructions cause the processor to operate as a first database, a second database, a search engine module, a credit determination module, a customer scoring module, and a customer ranking module. The first database is used to store system usage information of the system. The system usage information being associated with a plurality of customers of a retailer. The second database is used to store pricing information associated with a plurality of products for a plurality of other retailers. The search engine module receives a search engine search request. The search engine search request includes transaction data associated with one of the customers at the retailer. The transaction data includes a price of a product paid by the one of the customers during a transaction at the retailer. The search engine module performs a search of the second database as a function of the search engine search request and returns pricing information of the product associated with at least one of the other retailers. The credit determination module compares the price paid by the one of the customers and the pricing information of the product associated with at least one of the other retailers. The credit determination module awards the one of the customers a credit if the comparison of the price paid by the one of the customers and the pricing information of the product associated with at least one of the other retailers meets predefined criteria and stores the search engine search request and any awarded credit in the first database as usage information associated with the one of the customers. The customer scoring module analyzes the usage information of the system associated with the plurality of customers and establishes a customer score for each customer as a function of the credit awarded to the respective customer over a plurality of transactions and respective system usage information stored in the first database. The customer ranking module ranks the plurality of customers as a function of the respective customer score.

In still a further embodiment of the present invention, a system includes a memory, a first database, a second database, a search engine means, a credit determination means, a customer scoring means, and a customer ranking means. The first database means is used to store system usage information of the system. The system usage information being associated with a plurality of customers of a retailer. The second database means is used to store pricing information associated with a plurality of products for a plurality of other retailers. The search engine means receives a search engine search request. The search engine search request includes transaction data associated with one of the customers at the retailer. The transaction data includes a price of a product paid by the one of the customers during a transaction at the retailer. The search engine means performs a search of the second database as a function of the search engine search request and returns pricing information of the product associated with at least one of the other retailers. The credit determination means compares the price paid by the one of the customers and the pricing information of the product associated with at least one of the other retailers. The credit determination means awards the one of the customers a credit if the comparison of the price paid by the one of the customers and the pricing information of the product associated with at least one of the other retailers meets predefined criteria and stores the search engine search request and any awarded credit in the first database as usage information associated with the one of the customers. The customer scoring means analyzes the usage information of the system associated with the plurality of customers and establishes a customer score for each customer as a function of the credit awarded to the respective customer over a plurality of transactions and respective system usage information stored in the first database means. The customer ranking means ranks the plurality of customers as a function of the respective customer score.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic block diagram of a network environment suitable for implementing methods in accordance with embodiments of the invention;

FIG. 2 is a schematic block diagram of a computer system suitable for implementing methods in accordance with embodiments of the invention;

FIG. 3 is a schematic block diagram illustrating example components of a server, according to an embodiment of the present invention;

FIG. 4A is a process flow diagram of a method for ranking customers in accordance with an embodiment of the present invention;

FIG. 4B is a schematic block diagram illustrating components of a server for ranking customers, according an embodiment of the present invention;

FIG. 4C is a schematic block diagram illustrating components of a server for awarding badges to customers, according an embodiment of the present invention;

FIG. 4D is a schematic block diagram illustrating components of a server for awarding points customers, according an embodiment of the present invention;

FIG. 5 is a schematic block diagram of components implementing methods in accordance with an embodiment of the present invention;

FIG. 6 is a process flow diagram of a method for providing a credit based on price differences in accordance with an embodiment of the present invention;

FIG. 7 is a process flow diagram of a method for performing price matching in accordance with an embodiment of the present invention;

FIG. 8 is a process flow diagram of a method for determining an offering price in accordance with an embodiment of the present invention;

FIG. 9 is a process flow diagram of a method for pricing a product in accordance with an embodiment of the present invention;

FIG. 10 is a schematic block diagram of components implementing methods in accordance with an embodiment of the present invention;

FIG. 11 is a process flow diagram of a method for providing a credit based on price differences with fraud estimation in accordance with an embodiment of the present invention;

FIG. 12 is a schematic block diagram of components implementing methods in accordance with an embodiment of the present invention;

FIG. 13 is a process flow diagram of a method for providing a credit based on price differences with fraud estimation in accordance with an embodiment of the present invention; and

FIGS. 14A and 14B are a process flow diagram of a method for flagging potentially fraudulent transactions in accordance with an embodiment of the present invention.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

With reference to the FIGS. and in operation, the present invention provides a system 10, methods and computer product media that allow customers to submit sales transactions to the system. The system 10 compares the price(s) paid for products by the customers of a retailer to the price at which the products are available at other retailers. The system 10 may either award a credit to the customer if the price paid is greater than the price at which the product is available at another retailer, or inform the customer of the amount of the savings the customer experienced by making the purchase at the retailer. In addition, the system 10 tracks the amount of credits and savings experienced by the customers and the usage of the system 10 by the customer implements a customer incentive loyalty program by ranking the customers and issuing other awards, e.g., points and badges, to the customer(s) based on the associated usage of the system 10. The program implemented by the system 10 may be referred to as the Savings Catcher Program or the “Program”.

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media. An apparatus may be expressed in terms of modules and/or units that include one or more discrete hardware components or portions thereof as configured by software (in any form). Furthermore, an apparatus may take the form of one or more elements expressed as a means for performing a specified function. When expressed in such a form, the means are to be interpreted as meaning the combination of hardware components or portions thereof contained within this specification, and any equivalents thereof.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality and operation of possible implementations of systems, methods and computer program products, according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture, including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one, or a plurality of, a suitable protocol, as well as communication methods that are constantly maintained, are made on a periodic basis, and/or made or initiated on an as needed basis. The term “coupled” means any suitable communications link, including but not limited to, the Internet, a LAN, a cellular network or any suitable communications link. The communications link may include one or more of a wired and wireless connection and may be always connected, connected on a periodic basis, and/or connected on an as needed basis.

For clarity in discussing the various functions of the system 10, multiple computers and/or servers are discussed as performing different functions. These different computers (or servers) may, however, be implemented in multiple different ways, such as modules within a single computer, as nodes of a computer system, etc. . . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

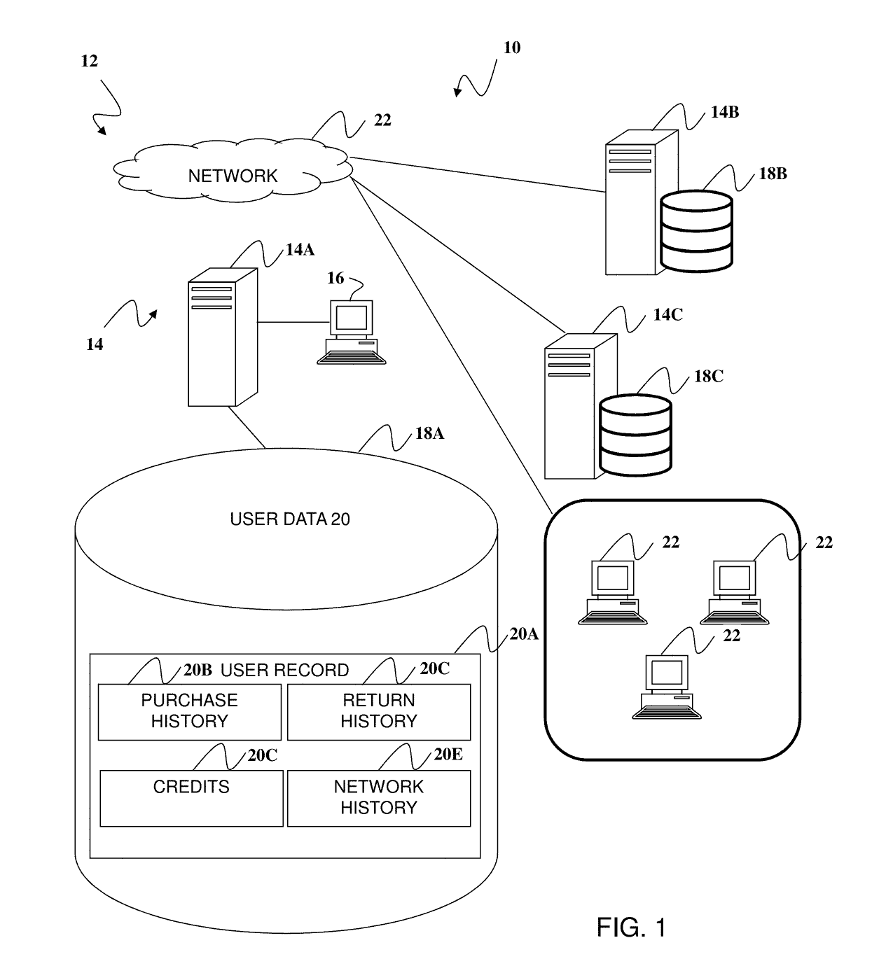

Referring to FIG. 1, an exemplary environment in which the system 10 operates is illustrated. It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. In some embodiments, a customer may conduct a transaction at a sale terminal or POS (point-of-sale) device. The transaction may include the purchase of one or more items, each having a purchase price paid by the customer. The transaction may be recorded in a transaction record, e.g. receipt, wherein each purchased item is represented by an item identifier. In some instances, the item identifier may be sufficient to also determine the price paid such that the price paid need not be included in the transaction record. For example, a product database may record the price for a given item identifier at a given date and/or time. In other embodiments, the transaction record may also include the price. The transaction record may be a paper receipt printed for the customer, and may also be an electronic record generated for a transaction by the POS and transmitted to a server.

A method may be executed with respect to the transaction. For example, subsequent to the first transaction, a server system may identify for each item identifier of at least a portion of the one or more item identifiers of a transaction, a third party record, the third party record corresponding to the each item identifier and having a third party price. For example, the third party record may include a competitor's advertisement or a transcription of pricing information from an advertisement by an entity that gathers pricing data.

The server system may identify one or more discounted identifiers of the one or more item identifiers, the third party price of the third party record corresponding to the discounted identifiers being less than the price paid for the one or more discounted identifiers by one or more price differences. The server system may then credit an account associated with the user identifier with an amount corresponding to the one or more price differences. The server system may then subsequently apply the amount towards a purchase price of a second transaction subsequent to the first transaction.

Any combination of the one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device and a magnetic storage device. In selected embodiments, a computer-readable medium may comprise any non-transitory medium that can contain, store, communicate, propagate or transport the program for use by or in connection with the instruction execution system, apparatus or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process, such that the instructions which execute on the computer or other programmable apparatus provide processes for implementing the functions/acts specified in the flowchart and/or block diagram block or blocks.

Referring to FIG. 1, the system 10 and methods, may operate in a network environment 12 may be used to implement methods as described herein. The environment 12 may include a server system 14, associated with a corporate parent or controlling entity, i.e., the retailer, having one or more retail establishments associated therewith. The retail establishments may include one or more sale terminals or point of sale devices (POS) 16 on which transactions may be concluded. Records of transactions may be transmitted to the server system 14 by the sale terminal 16 at the various retail establishments.

In some embodiments, data regarding third parties and used according to the methods disclosed herein, may be gathered from various sources. For example, a server 14b of one entity may provide a website providing access to an online product database 16C, which may include access to product records including product prices, corresponding product identifiers and other descriptive information. A database 18B may also include a publicly accessible website or the like listing advertisements for products offered for sale in a retail establishment.

In some embodiments, data regarding third parties may be obtained from a server or server system 14C operated by a data gathering entity. For example, the server system 14C may store third party pricing data 18c. The pricing data 18C may include data gathered from advertisements published by retail entities. Pricing data could include entries including fields such as an entity identifier, location, price, product identifier (e.g. UPC), a date the product was offered at the price or the like. The pricing data may be gathered and be provided within N day of Hours from when it was published. For example, pricing data may be provided the next day, 48 hours, or 72 hours, after initially publicized.

The server system 14, or server 14A, may access and use user data 20 which may include a plurality of user records 20A. A user record 20A may be associated with a particular user who may be identified by a unique customer identifier. The user may have access to some or all of the data in the user record, and a user name and password may be associated with the user record and with which a user may log in the server system 14 in order to obtain access to the user record 20A.

The user record 20A may include such data as a purchase history 20B, including a record of previous transactions conducted by the user associated with the user record 20A at the various sale terminals 16 associated with the server system 14. The user record 20A may further include a record of credits 20C assigned to the user/customer associated with the user record, as well as a redemption or usage of such credits. The methods by which the credits 20C are assigned and used are described in greater detail below.

In some embodiments, fraud detection methods (see below) as described herein may evaluate the purchase history 20B, credits 20C, and one or more other type of information about a user associated with the user record 20A. For example, a return history 20D of a user that indicates which items were returned by the user and when may be included in the user record 20A. A network history 20E may store aspects of a user's electronic interactions with the server system 14, such as a type of device used by the user when interacting with the server system 14, an identifier of the device, a type of browser used, the internet protocol (IP) address of the device, browser user-agent, and the like, may be stored as part of the network history 20E.

Customers may access the server system 14 in order to participate in the methods described herein by means of user computing devices 22 that may be embodied as desktop or laptop computers, tablet computers, smart phones, or the like. Communication among server system 14, servers 14A, 14B, 14C, sale terminals 16, and user computing devices 22 may occur over a network 24, such as the Internet, local area network (LAN), wide area network (WAN) or any other network topology. Communication may be over any wired or wireless connection.

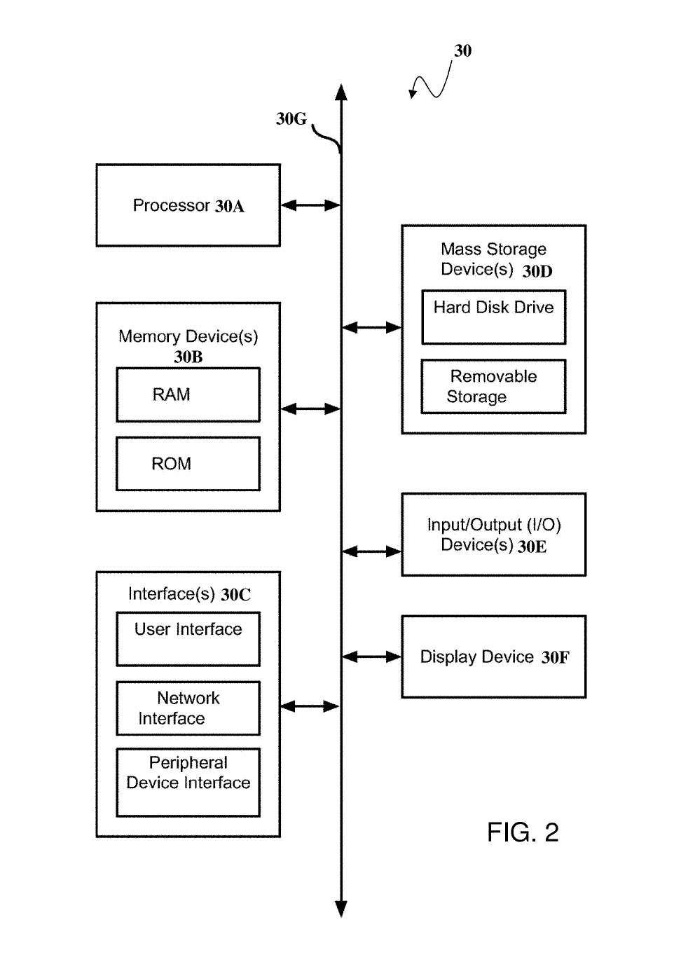

FIG. 2 is a block diagram illustrating an example computing device 30. Computing device 30 may be used to perform various procedures, such as those discussed herein. The server system 14, servers 14A, 14B, 14C, sale terminals 16, and user computing device 22 may have some or all of the attributes of the computing device 30. Computing device 30 can function as a server, a client or any other computing entity. Computing device 30 can perform various monitoring functions as discussed herein, and can execute one or more application programs, such as the application programs described herein. Computing device 30 can be any of a wide variety of computing devices, such as a desktop computer, a notebook computer, a server computer, a handheld computer, tablet computer and the like. For example, the servers 14A, 14B, 14C may include one or more computing devices 30, each including one or more processors.

Computing device 30 includes one or more processor(s) 30A, one or more memory device(s) 30B, one or more interface(s) 30C, one or more mass storage device(s) 30D, one or more Input/Output (I/O) device(s) 30E, and a display device 30F, all of which are coupled to a bus 30G. Processor(s) 30A include one or more processors or controllers that execute instructions stored in memory device(s) 30B and/or mass storage device(s) 30D. Processor(s) 30A may also include various types of computer-readable media, such as cache memory.

Memory device(s) 30B include various computer-readable media, such as volatile memory, e.g., random access memory (RAM) and/or nonvolatile memory, e.g., read-only memory (ROM). Memory device(s) 30B may also include rewritable ROM, such as Flash memory.

Mass storage device(s) 30D include various computer-readable media, such as magnetic tapes, magnetic disks, optical disks, solid-state memory, e.g., Flash memory, and so forth. As shown in FIG. 2, a particular mass storage device is a hard disk drive. Various drives may also be included in mass storage device(s) 30D to enable reading from and/or writing to the various computer-readable media. Mass storage device(s) 30D include removable media and/or non-removable media.

I/O device(s) 30E include various devices that allow data and/or other information to be inputted to or retrieved from computing device 30. Example I/O device(s) 30E include cursor control devices, keyboards, keypads, microphones, monitors or other display devices, speakers, printers, network interface cards, modems, lenses, CCDs or other image capture devices and the like.

Display device 30F includes any type of device capable of displaying information to one or more users of computing device 30. Examples of display device 30F include a monitor, display terminal, video projection device and the like.

Interface(s) 30C include various interfaces that allow computing device 30 to interact with other systems, devices, or computing environments. Example interface(s) 30C include any number of different network interfaces 30C, such as interfaces to local area networks (LANs), wide area networks (WANs), wireless networks and the Internet. Other interface(s) include user interface and peripheral device interfaces. The interface(s) 30C may also include one or more user interface elements. The interface(s) 30C may also include one or more peripheral interfaces, such as interfaces for printers, pointing devices (mice, track pads, etc.), keyboards and the like.

Bus 30G allows processor(s) 30A, memory device(s) 30B, interface(s) 30C, mass storage device(s) 30D, and I/O device(s) 30E to communicate with one another, as well as other devices or components coupled to bus 30G. Bus 30G represents one or more of several types of bus structures, such as a system bus, PCI bus, IEEE 1394 bus, USB bus and so forth.

Other aspects of the system 10 and the Program may be found in commonly owned U.S. Patent Application Publication No. 2014/0304059, filed on May 30, 2014 which is hereby incorporated by reference; US Patent Application Publication 2014/0278902, filed on May 30, 2014 which is hereby incorporated by reference; US Patent Application Publication 2014/0278903, filed on May 30, 2014 which is hereby incorporated by reference; and US Patent Application Publication 2014/078883, filed on May 30, 2014 which is hereby incorporated by reference.

For purposes of illustration, programs and other executable program components are shown herein as discrete blocks, although it is understood that such programs and components may reside at various times in different storage components of computing device 30, and are executed by processor(s) 30A. Alternatively, the systems and procedures described herein can be implemented in hardware, or a combination of hardware, software and/or firmware. For example, one or more application specific integrated circuits (ASICs) can be programmed to carry out one or more of the systems and procedures described herein.

### Customer Loyalty/Reward Program

In some embodiments of the present invention, the system 10 may track the customer's usage of the system and reward the customer's usage of the system 10. In general, the system 10 may be used to provide incentives to the customer to make purchases at the retailer. The system 10 encourages customers to make purchases at the retailer by: (1) providing a credit to the customer if the price paid for a product at the retailer is higher than the price at which the product is available at other retailers and/or (2) informing the customer(s) of the savings the customer incurred by purchasing the product at the retailer instead of another retailer. The system 10 may encourage customers to use the system by providing other incentives to the customer(s) based on their usage of the system 10. Customers may enroll in a program that checks their purchases against competitor's prices automatically, or in response to the customer submitting their transactions or receipts to the system 10.

There are multiple ways to engage customers enrolled in the Program apart from providing the lowest prices for their purchases. For example, the Program may provide a game-like ranking to the customers based on their level of participation in the Program. The rank can be based on various parameters related to the customers' participation, such as rewards earned from the program, dollars saved from purchases of items where the retailer price beat all the competitors' prices, participation in terms of revenue, purchases, variety of products purchased and multi-channel purchases. Customers can improve their rank with smarter purchases of items where the most money is saved on items where resulting in the most rewards or various other parameters used for determining the customers' ranking. Apart from ranking the customers, the Program may also award badges to customers based on their purchases in specific product categories. For example, the Program may award the following or similar badges: Smart Mom, Pet Lover, Sports Enthusiast, Trend Setter, etc. . . . . Badges may be awarded based on other aspects of the customer's purchases. Badges may be shared on social networks.

In addition, customers can accumulate points which can then be used to assign a customer to a game-like tier such as: Standard (0-100 points), Bronze (101-200 points), Silver (201-500), etc. The accrued points may be used to provide discounted services such as discounts in purchases, rewards multiplier for Program rewards, rewards, promotions or promotional offers on shipping discounts, entertainment, e.g., video rentals, online shopping discount, or discounts on particular products or product categories, services, etc. . . . , based on the tier-system for the points. Rewards accrued in different tiers may have different multipliers. A customer's tier level may be shared on social networks.

In order to make the program more social in nature, the Program may be used by customers to invite their families, friends and other acquaintances known to participate in the Program. The referral initiatives can be used to award more points to both the customer and to the people to whom the customer sends invitations. Customers can also be allowed to share the details of their participation, such as rank, badges, points, or top savings products on their choice of social media that are supported by the Program. This will help in building a social connection for the Program and can be used to encourage participation and also allow customers to showcase their progress in the Program ranks. Referrals, invitations and/or accepted invitations may also lead to points being awarded. Points earned and/or used may be shared on social networks.

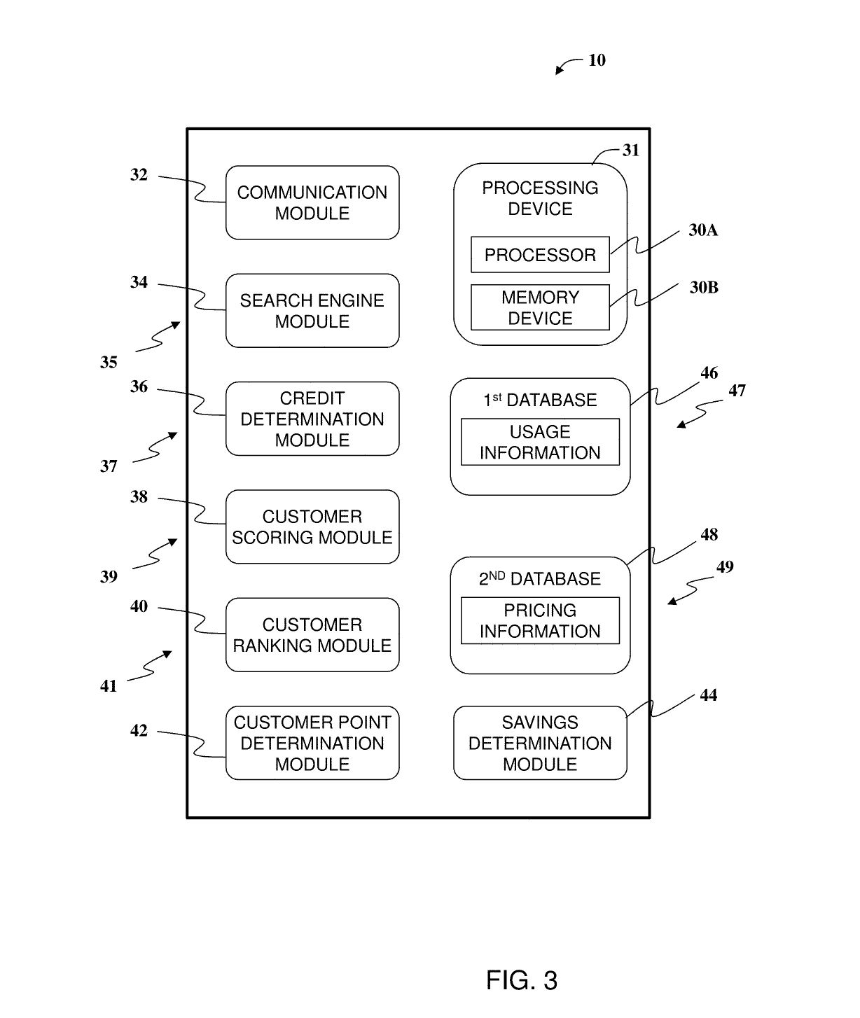

With reference to FIG. 3, the system 10 is used to implement the Program, and in particular, the customer loyalty/award component of the system 10, may include a processing device 31, communication module 32, a search engine module 34, a credit determination module 36, a customer scoring module 38, a customer ranking module 40, a first database 46, and a second database 48.

The processing device 31 executes various programs, and thereby controls components of the system 10 according to user instructions received from the user computing device 22. The processing device 31 may include a processor or processors 30A and a memory device 30B, e.g., read-only memory (ROM) and random access memory (RAM), storing processor-executable instructions and one or more processors that execute the processor-executable instructions. In embodiments where the processing device 31 includes two or more processors 30A, the processors 30A can operate in a parallel or distributed manner.

The memory device 30B may be configured to store programs and information in the first and second databases 46, 48, and retrieving information from the databases 46, 48 that is used by the processor to perform various functions described herein. The memory device 30B may include, but is not limited to, a hard disc drive, an optical disc drive, and/or a flash memory drive. Further, the memory device 30B may be distributed and located at multiple locations.

The communications module 32 retrieves various data and information from the databases 46, 48, and sends information to the user computing device 22 via the network 24 to enable the user to access and interact with the system 10. In one embodiment, the communications module 32 displays various images on a graphical interface of the user computing device 22, preferably by using computer graphics and image data including, but not limited to, web pages, product records, sorted groups, product lists, and/or any suitable information and/or images that enable the system 10 to function as described herein.

The search engine module 34 may be programmed to perform a plurality of features, including, but not to, generating and storing search data in response to a search engine search request.

Returning to FIG. 3, the first database 46 is configured to store system usage information of the system 10. The system usage information is associated with a plurality of customers of a retailer. In one embodiment, the customers log on to the system 10 and submit records of their transactions, e.g., receipts, to the system 10 using a user computing device 22. As explained in more detail below, the credit determination module 36 and the savings determination module 44 compare price(s) paid by the customer at the retailer with the prices for the same product at another retailer, for example, a competing retailer, and either award the customer a credit if the price paid is higher than the competitor's price, or inform the customer how much the customer has saved by purchasing the product at the retailer (instead of the competitor), respectively. The credit may be awarded to the customer and applied to a later transaction, e.g., at the same retailer. Alternatively, the customer may be informed of the amount of the savings. Information regarding each submitted transaction, including but not limited to, the number of submitted transactions, an aggregate credit amount and an aggregate savings amount may be stored in, as part of the stored usage information.

The second database 48 is configured to store pricing information associated with a plurality of products for a plurality of other retailers. As discussed above, and in more detail below, the pricing information may be gathered from a plurality of sources. Furthermore, the pricing information to which the customer's purchase price(s) are compared may be limited or filtered based on geography and/or time.

The search engine module 34 is coupled to the second database 48 and is configured to receive a search engine search request. The search engine search request generally includes transaction data associated with one of the customers at the retailer. The transaction data includes a price of a product paid by the one of the customers during a transaction at the retailer. The search engine search request may be generated in response to a customer's request for review of the transaction to the system 10 via a user computing device 22. Alternatively, the search engine search request may be generated in response to receiving an automatic request from a sale terminal 16.

The search engine module 34 is further configured to perform a search of the second database 48 as a function of the search engine search request and to return pricing information of the product associated with at least one of the other retailers. As discussed above, the pricing information returned by the search engine module 34 may be limited in time and/or geographically relative to the customer's transaction.

The credit determination module 36 is coupled to the first database 46 and the search engine module 34, and is configured to compare the price paid by the one of the customers and the pricing information of the product associated with at least one of the other retailers. The credit determination module 36 being further configured to award the one of the customers a credit if the comparison of the price paid by the one of the customers and the pricing information of the product associated with at least one of the other retailers meets predefined criteria and to store the search engine search request and any awarded credit in the first database 46 as usage information associated with the one of the customers.

The customer scoring module 38 is coupled to the first database 46 and is configured to analyze the usage information of the system associated with the plurality of customers and to establish a customer score for each customer as a function of the credit awarded to the respective customer over a plurality of transactions and respective system usage information stored in the first database 46.

The customer ranking module 40 is coupled to the first database 46 and is configured to rank the plurality of customers as a function of the respective customer score.

In one aspect of the present invention, the search engine module 34 is further configured to receive multiple search engine search requests for the one of the customers. Each search request may be either for a specific product, or for a respective transaction (containing one or more purchased products). Each search engine search request is associated with a respective transaction at the retailer. Each transaction has at least one other product associated therewith. The search engine module 34 is further configured to perform a search of the second database 48 as a function of each search engine search request and return pricing information associated with the at least one other product of the respective transaction associated with at least one of the other retailers.

The credit determination module 36 is further configured to award a credit to the customer as a function of a price paid by the one of the customers for the at least one other product and the pricing information of the at least one other product associated with the at least one of the other retailers.

In one embodiment of the present invention, the system 10 includes a savings determination module 44. The savings determination module 44 is coupled to the first database 46 and the search engine module 34, and is configured to compare the price paid by the one of the customers and the pricing information of the at least one other product associated with the at least one of the other retailers and to establish a savings amount representing an amount saved by the customer for purchasing the product at the retailer. The customer scoring module 38 establishes the customer score as a function of the amount of credit awarded to the respective customer and/or an amount of savings made by the respective customer over a plurality of transactions.

In another embodiment of the present invention, the customer scoring module 38 establishes the customer score as a function of a number of transactions stored in the first database associated with the one of the customers. The number of transactions used to establish the customer score may be the total number of customer transactions, or the number of transactions submitted to the Program for review. The number of transactions used to establish the customer score may be limited in time or geography (relative to the submitted transaction).

Other factors or parameters may also be used in the customer score determination, for example, the number of unique products associated with the number of transactions stored in the first database and associated with the one of the customers.

Each transaction may be performed over one of a plurality of retail channels, for example, the transaction could have been performed online, via a website, at a retail store, or via a mobile device app or other channel. The customer scoring module is further configured to establish the customer score as a function of the number of retail channels utilized by the one of the customers.

In one embodiment, the customer score is determined as:
f(retailPrice, savings, receiptCount, upcCount, avgTotalScanCount, lowPriceRetailPrice, numberOfChannelsParticipated, rewards),
   where retailPrice is the total price of all receipts, transactions or items that the customer has submitted to the Program, rewards is the total rewards or credits awarded to the customer based on the submitted receipts/items, savings is the total amount of savings the customer has accrued by buying the items on the receipts, transaction or items submitted to the Program, receiptCount is the total number of receipts or transaction submitted by the customer to the Program, upcCount is the total count of a unique product or universal product codes (UPC) purchased by the customer across all submitted receipts), lowPriceRetailPrice is the total retail price of all items for which the retail price of the retailer was lower than all competitor prices, and numberOfChannelsParticipated is the number of channels through which the customer had made purchases for the submitted transactions. It should be noted that the present invention is not limited to the above expression used to establish the customer score.

In another embodiment of the present invention, the customer score may be established using the formula:

$$CustomerScore = ( log ( log ( retailPrice - rewards + savings + e ) ⋆ 10000 ⋆ π ⋆ e ) ⋆ 100 + receiptCount + log ( upcCount ⋆ 10 + e ⋆ 10 ) + log ( avgTotalScanCount ⋆ π + e ) + log ( log ( \frac{retailPrice}{receiptCount} ⋆ 1.5 + e + \frac{lowPriceRetailPrice}{retailPrice} ⋆ 100 ) + e ) ⋆ 10 ) + log ( numberOfChannelsParticipated * 1.5 + e ) .$$

Generally, the ranking of the customers is based on the customer scores. A customer with a higher customer score than another customer will have a higher ranking. However, in other embodiments, other factors may also affect customer rankings. For example, customer rankings may also be affected by total credits awarded to the customer, total savings experienced by the customer across submitted transactions, level of participation in the Program, revenue, i.e., total spent, by the customer at the retailer or in the submitted transactions and multiple channel behavior (see above).

In another aspect of the invention, customers may be ranked at different levels. For example, as stated above, rankings for the customers may be established on a particular store basis, regional basis, and/or global basis. Rankings may be further established on a channel by channel basis.

In another aspect of the present invention, the system 10 may also include a customer point determination module 42. The customer point determination module 42 is coupled to the first database 46 and is configured to analyze the usage information of the system 10 associated with the plurality of customers and the ranking of the plurality of customers and to responsively establish a number of customer points for each customer. The customer points associated with each customer are stored in the first database 46. The customer points may be exchanged for products and/or services, or discounts on products or services.

In one embodiment, the customer point determination module 42 is further configured to establish the number of customer points for each customer as a function of a number of times the respective customer has shared usage information of the system over a social network.

In another embodiment, the customer point determination module 42 is further configured to establish the number of customer points for each customer as a function of a number of referrals made by the respective customer to other customers.

In still another embodiment, the customer point determination module 42 is further configured to establish the number of customer points for each customer as a function of a number of orders made by the respective customer at a retail website associated with the retailer.

In a further embodiment, the customer point determination module 42 is further configured to establish the number of customer points for each customer as a function of a number of different departments associated with the retailer at which the respective customer has purchases product(s).

In a still further embodiment, the customer point determination module 42 establishes the number of customer points for a customer as follows:

CustomerPoints=f(CustomerRank,SocialShareCount,Referrals,DotComOrderCount, DotComDepartmentCount)

In a particular, non-limiting example, the customer point determination module 42 establishes the number of customer points for a customer using the formula:

$$CustomerPoints = log ( \frac{1000}{CustomerRank} + e ) + log ( SocialShareCount + e ) + log ( Referrals ⋆ 1.5 + e ) + log ( DotComOrderCount ⋆ 0.5 + e ) + log ( DotComDepartmentCount ⋆ 0.5 + e )$$

In one embodiment of the present invention, the memory device 30B may include one or more of the memory devices and/or mass storage devices of one or more of the computing devices or servers. The modules that comprise the invention are composed of a combination of hardware and software, i.e., the hardware as modified by the applicable software applications. In one embodiment, the units of the present invention are comprised of one or more of the components of one or more of the computing devices or servers, as modified by one or more software applications.

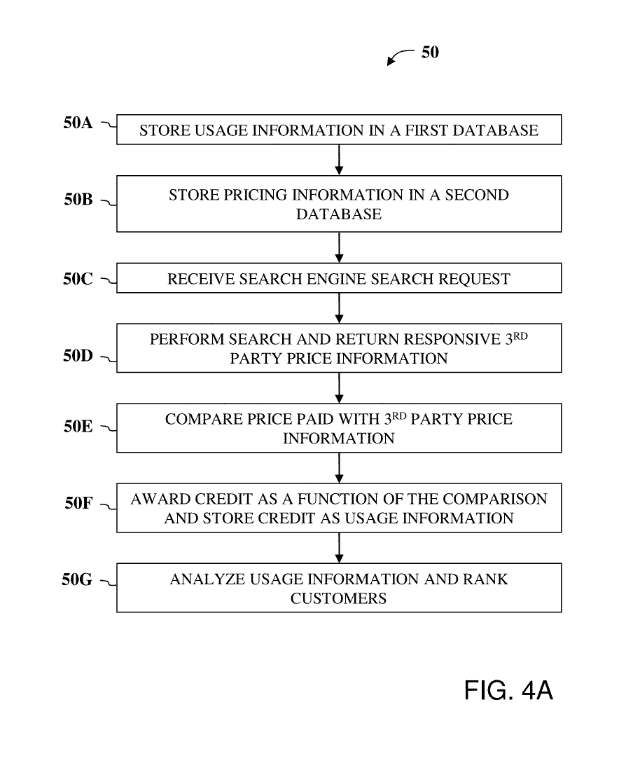

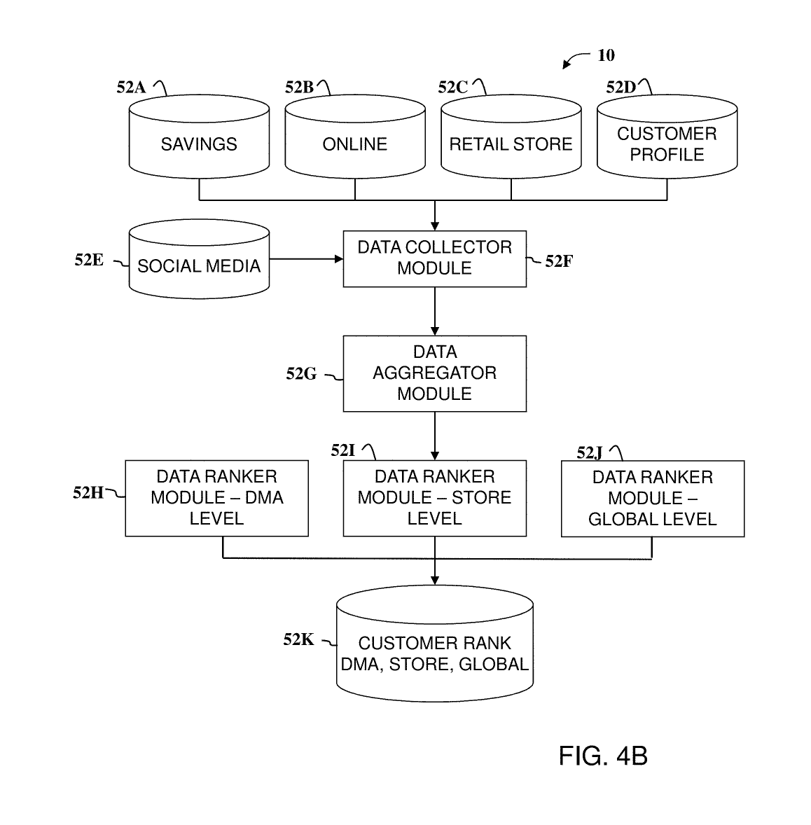

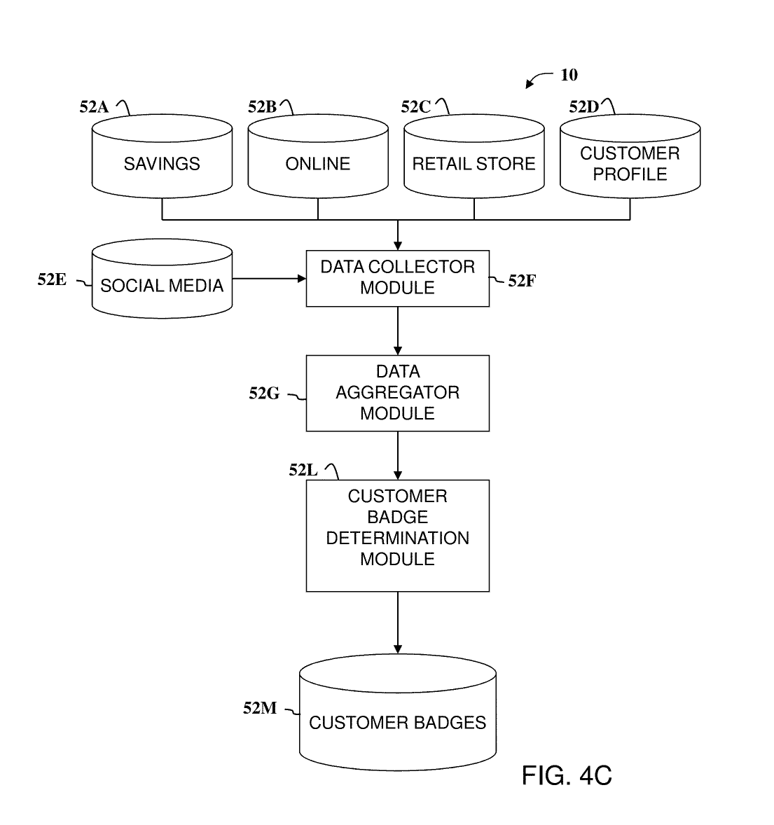

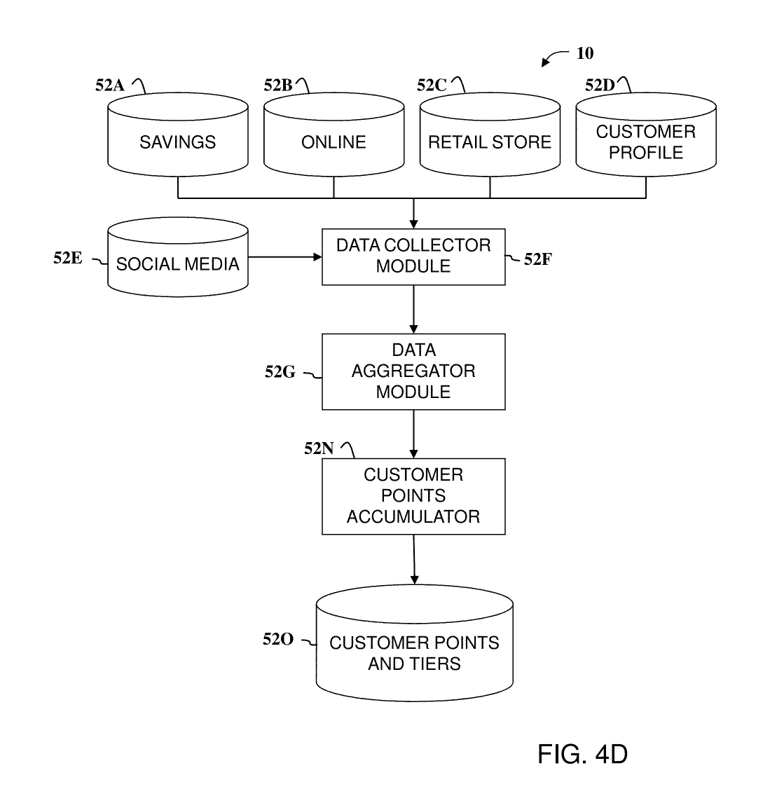

FIG. 4A is a flowchart of method 50 that may be used with the system 10 to allow users or customers to submit transactions to the system 10 for evaluation under the Program. The method includes a plurality of steps. Each method step may be performed independently of, or in combination with, other method steps. Portions of the method may be performed by any one of, or any combination of, the components of the system 10.

In a first step 50A, usage information of the system 10 is stored in the first database 46. The system usage information is associated with a plurality of customers of a retailer. In a second step 50B, pricing information associated with a plurality of products for a plurality of other retailers is stored in the second database 48.

A search engine search request is received at the search engine module 34 in third step 50C. The search engine search request includes transaction data associated with one of the customers at the retailer. The transaction data includes a price of a product paid by the one of the customers during a transaction at the retailer. In a fourth step 50D, a search of the second database 48 is performed by the search engine module 34 as a function of the search engine search request, and pricing information of the product associated with at least one of the other retailers is returned.

In a fifth step 50E, the price paid by the one of the customers and the pricing information of the product associated with at least one of the other retailers is compared. The customer is awarded a credit, in a sixth step 50F, if the comparison of the price paid by the one of the customers and the pricing information of the product associated with at least one of the other retailers meets predefined criteria. For example, a credit is awarded if the price paid by the one of the customers is greater than the competitor's pricing information. The search engine search request and any awarded credit are stored in the first database as usage information associated with the one of the customers. Generally, the amount of the credit is a function of the difference between the price paid and the competitor's price.

In a seventh step 50G, the usage information of the system associated with the plurality of customers is analyzed and a customer score for each customer as a function of the credit awarded to the respective customer over a plurality of transactions and respective system usage information stored in the first database is established. The customers are ranked as a function of the respective customer score.

Returning to FIG. 2, in still a further embodiment of the present invention, the system 10 may include first database means 47, second database means 49, search engine means 35, credit determination means 37, customer scoring means 39, and customer ranking means 41.

The first database means 47 stores system usage information of the system 10 associated with a plurality of customers of a retailer. The second database means 49 stores pricing information associated with a plurality of products for a plurality of other retailers.

The first and second databases 47, 49 may be implemented by one or more of the servers 14A, 14B, 14C of the server system 14. The first and second databases 47, 49 may be distributed and located at one or multiple locations.

The search engine means 35 receives a search engine search request. The search engine search request includes transaction data associated with one of the customers at the retailer. The transaction data includes a price of a product paid by the one of the customers during a transaction at the retailer. The search engine means 35 performs a search of the second database means 49 as a function of the search engine search request and returns pricing information of the product associated with at least one of the other retailers. The search engine means 35 may be implemented, at least in part, by the processing device 31, including the processor or processors 30A and the memory device 30B.

The credit determination means 37 compares the price paid by the one of the customers and the pricing information of the product associated with at least one of the other retailers. The credit determination means 37 awards the one of the customers a credit if the comparison of the price paid by the one of the customers and the pricing information of the product associated with at least one of the other retailers meets predefined criteria. The credit determination means 37 further stores the search engine search request and any awarded credit in the first database means 47 as usage information associated with the one of the customers. The credit determination means 37 may be implemented, at least in part, by the processing device 31, including the processor or processors 30A and the memory device 30B.

The customer scoring means 39 analyzes the usage information of the system 10 associated with the plurality of customers and establishes a customer score for each customer as a function of the credit awarded to the respective customer over a plurality of transactions and respective system usage information stored in the first database means 47. The customer scoring means 39 may be implemented, at least in part, by the processing device 31, including the processor or processors 30A and the memory device 30B.

The customer ranking means 41 ranks the plurality of customers as a function of the respective customer score. The customer ranking means 41 may be implemented, at least in part, by the processing device 31, including the processor or processors 30A and the memory device 30B.

With respect to FIGS. 4B-4D in another aspect of the present invention the system may be configured to provide a game-like contest or the like, in which the customers compete for customer rankings, customer points, and/or badges. The customer rankings, customer points and/or badges may be awarded to customers solely for “bragging” rights, e.g., for sharing on social media sites and/or for exchange or for redemption for goods, services, discounts, coupons, and the like.

With respect to FIG. 4B, the system 10 is described with respect to the determination of customer rankings. Data is collected by a data collector module 52F from a variety of sources. The sources are shown as various databases: a savings collector database 52A, an online database 52B, a retail store database 52C, a customer profile database 52D, and a social media database 52E. The databases 52A, 52B, 52C, 52D, 52E may be separate databases located at on different servers within the server system 14. Alternately, one of more of the databases 52A, 52B, 52C, 52D, 52E may combined in a single database.

The savings database 52A contains data with respect to the customers' savings and/or credits tracked, managed, and/or awarded by the Program. The online database 52B is configured to store data related to the customers' online orders. The retail store database 52C is configured to store data related to the customers' in-store purchases. The customer profile database 52D is configured to store the customer accounts. The social media database 52E is configured to store data related to the customers' social media accounts, including, e.g., the Program information (credits, savings, badges, points) that the customers have shared on their social media accounts.

The data collector module 52F identifies and collects information for the customers in the customer profile database 52D across multiple sources, e.g., data stored in the savings database 52A, the online database 52B, the retail store database 52C and the social media database 52E.

A data aggregator module 52G aggregates the data for each customer over the multiple sources/channels and timelines. For example, a particular contest or award or points or rankings or badge, may be run for a particular time period.

The data aggregated by the data aggregator module 52G is analyzed on to determine customer rankings (see above). Rankings may be determined at different levels, e.g., different geographic areas. In the illustrated embodiment rankings may be established at a regional level, i.e., a designated market area or DMA 52H, individual store(s) level 52I and/or overall or global level 52J.

The rankings are then stored in a customer rank database 52K. Rankings may then be can be used to show Customer's position on a leader dashboard at a retailer website and/or social website. In one aspect of the present invention, customers have a specific ranking may awarded gifts, goods, services, discounts, coupons, and the like.

With reference to FIG. 4C, the data collector module 52F and the data aggregator module 52G feed information to a customer badge determination module 52L that analyzes the collected data and awards badges to the customer(s) if the customer has met specific, predefined criteria. Sample badges include: Smart Mom, Pet Lover, Sports Enthusiast, Trend Setter, etc. . . . . When a customer earns a badge, the badge is stored in a customer database 52M and may be shared on social media. The predefined criteria may include, e.g., that a customer has purchased specific products, types of products, and/or categories of products and/or spent a particular amount. In one aspect of the present invention, customers have earned a particular badge may awarded gifts, goods, services, discounts, coupons, and the like.

With reference to FIG. 4D, the data collector module 52F and the data aggregator module 52G feed information to a customer points accumulator module 52N that analyzes the collected data and awards points to the customer(s) if the customer (see above). The number of customer points may also be used to place customer in different tier levels, e.g., platinum, gold, silver. The customers' point and tier-levels are stored in a customer database 520 and may be shared on social media.

On-Line and in-Store Purchases

Transactions processed according to the methods herein may be online transactions, as well as in-store transactions. In some embodiments, a credit for an in-store transaction may be applied to an online transaction, thereby linking the in-store and online transactions to the same user. The aggregate online and in-store transactions may then be used to better characterize the interests of the user. In a like manner, a credit or an online transaction may be applied to an in-store transaction, thereby establishing an association between the transactions.

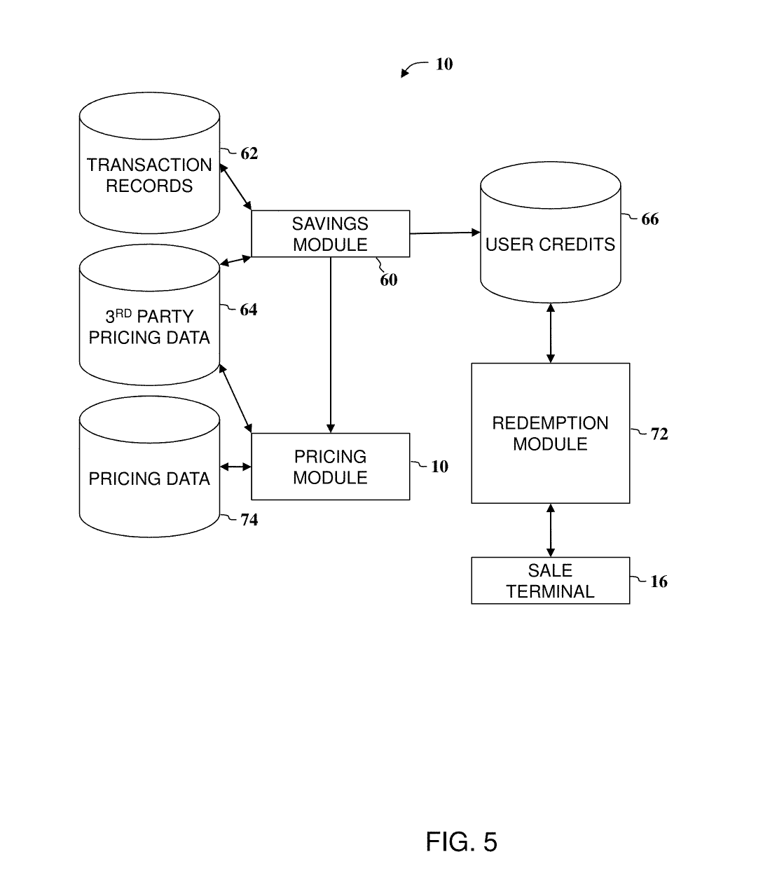

With reference to FIGS. 5-9, an embodiment of the system 10 configured to compare the prices based on in-store and online purchases with competitor pricing is shown.

Referring to FIG. 5, a savings module 60 may ingest data such as a transaction record (e.g. receipt) from among user transaction records 62. The user transaction records 62 may be stored in the associated user record(s) 20A. The savings module 60 may further take as input third party pricing data 64. The third party pricing data may be stored in the second database 48. The third party pricing data 64 may be pricing data from different entities than the entity that conducted the transaction represented by the transaction record. The third party pricing data 64 may be data that reflects prices offered on the same day as a date on which the transaction represented by the transaction record took place. The savings module 60 compares the prices of items in the transaction record to prices for corresponding items in the third party pricing data 64. The savings module then assigns user credits 66 to an account of the user associated with the transaction or otherwise attributes credits 66 to the user.

A pricing module 68 may access the third party pricing data 64 in order to determine prices for items to be stored in pricing data 70 of an entity performing the methods disclosed herein. The pricing module 68 may use third party pricing data, as well as observations of customer behavior in order to determine an appropriate price for an item. Methods for determining pricing for items will be described in greater detail below.

A redemption module 72 may interact with one or more sale or point-of-sale (POS) terminals to apply the credits to subsequent transactions. For example, the redemption module 72 may issue a gift card, code for a gift card, assign credits to a gift card, or otherwise provide a message containing information that a user may use at a sale terminal 16 in order to apply the credits to a transaction. The redemption module 72 may interact with the sale terminal 16 in order to validate a gift card, code or other representation of credits presented at the sale terminal 16 when processing payment for a transaction. For example, a cashier or device may receive the code, scan the gift card, swipe the gift card through a magnetic reader or otherwise input a representation of the gift card into the sale terminal 16. The sale terminal 16 may then transmit this information, or a representation thereof, to the redemption module 72. If the transmitted information is valid, the redemption module 72 may transmit authorization to the sale terminal 16 to apply corresponding credits to the transaction. Otherwise, the redemption module 72 may transmit a rejection of the transmitted information and the sale terminal 16 will not apply any corresponding credits to the transaction. The redemption module 72 may interact with in-store sale terminal 16, as well as sale terminal 16 that processes online transactions.

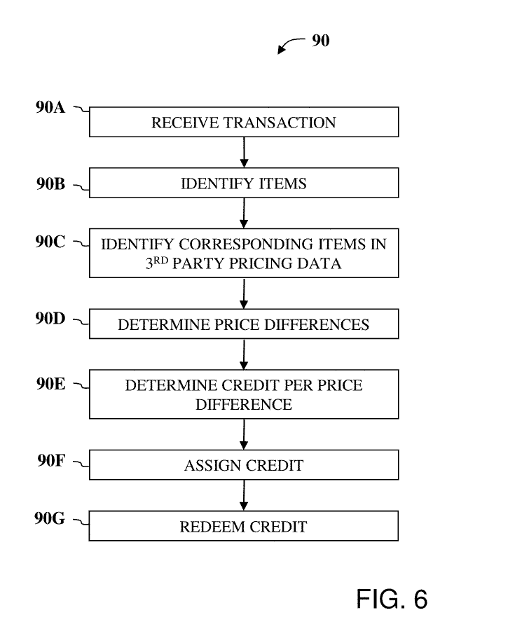

FIG. 6 illustrates an example of a method 90 that may be used to provide credits to users based on a price difference between a price paid and third party prices. The method 90 may include receiving 90A a record of a transaction. A record of a transaction may include such data as a date of the transaction, a location where the transaction occurred, an identifier of the sale terminal 16 at which the transaction occurred, an identifier of the customer that was a party to the transaction and other information. The transaction record may further include various <product, price> entries that list a product identifier and a price paid for the product corresponding to that product identifier. Other data may include taxes paid for the entire transaction and/or for specific item identifiers. Any discounts due to coupons or price matching may also be noted for each item identifier for which such price adjustments were applied. The transaction record may be transmitted from a sale terminal 16 to server system 14. The transaction record may additionally or alternatively be transmitted to a customer in electronic form and/or by means of a printed copy. The transaction record may be associated by the server system 14 with the user data 20 of a user with whom the transaction was conducted, such as using a credit card number or identifier supplied to the sale terminal at the time of concluding the transaction and included in, or associated with, the transaction record. For example, the transaction record may be in the form of an electronic receipt provided to the customer.

The step of receiving 90A the receipt may include receiving a transaction identifier from a user computing device 22 through a portal, such as a website hosted by the server system 14. The transaction identifier may uniquely identify the transaction record and may be printed on a paper receipt to enable the customer to take advantage of the methods disclosed herein and/or for other purposes. Receiving 90A the receipt may include receiving, by the server system 14, a selection of the transaction in a listing of transactions presented in a portal provided by the server system 14 or by an application for viewing receipts stored locally on a user computing device 22. For example, transactions may be made available to a user in the form of electronic receipts stored in an account of a user and recording transactions conducted by the user. In some embodiments, all transactions of a user may be submitted for review according to the method 90. For example, where a user has installed a mobile application for interfacing with the server system 14, all transactions of a user may be automatically submitted for review according to the method 90. In some embodiments, transactions may be transmitted to the server system by 1) the user scanning a bar code or other optical code printed on a receipt with a user device 22, 2) the user device 22 transmitting some representation of the optical code to the server system 14 and 3) the server system 14 identifying a transaction record corresponding to the transmitted representation of the optical code.

In some embodiments, the server system 14 may limit a number of receipts that may be submitted by a customer, e.g. for a specific user account. For example, N transactions may be process per week for the customer. In some embodiments, multiple limits on receipts for multiple corresponding time period may be imposed. For example, only N transactions per week or M transactions per month may be allowed by the server system 14 to be processed according to the methods described herein for purposes of determining a credit based on price differences.

In some embodiments, transactions received may be online transactions concluded by the server system 14. In such embodiments, all transactions conducted by a user may be processed according to the method 90. The number of online transactions that may be processed according to the method 90 within a given period may be limited as described above.

The method 90 may further include identifying 90B from the received transaction record the item identifiers of items purchased as part of the transaction and the price for each item. For example, fields of the form <item identifier, price paid> may be filled with the item identifier and purchase price for some or all items listed as having been purchased in a transaction record. The item identifier may be a proprietary product identifier for a product catalog of a merchant or a universal identifier (e.g. a universal product code (UPC)).

For some or all of the identified 90B items, corresponding items may be identified in third party pricing data. In particular, a lowest price for each item identifier may be identified 90C among the third party pricing data. As noted above, pricing data may include advertised prices exclusively. Pricing data may also include the sale price for some items regardless of whether that price is advertised. Pricing data searched to identify corresponding third party prices may be limited to pricing data for retail stores within a threshold proximity of the sale terminal or retail location identified by the transaction record that is the subject of the method 90. For example, the threshold may reference a geographical or political region (neighborhood, city, county, state, etc.) or may specify a circular area having a radius R with respect to the sale terminal or store location indicated in the transaction record.

Identifying the lowest price among the third party pricing data for each item identifier of at least a portion of the item identifiers in a transaction may include determining a per-unit cost for corresponding items in the third party pricing data. For example, if a product corresponding to an item identifier is offered for sale as a buy N at price P per unit and get M free, then the price of an individual instance of that product may be prorated to be (N/(N+M))*P. This prorated price may then be used for purposes of determining whether a price is the lowest as compared to prices offered for that product by other entities and for comparison with the purchase price for the corresponding item identifier in the transaction record. In some instances, where items are sold by a unit of measure, such as weight, the cost per unit weight for an item may also be determined form the third party pricing data. For example, this approach may be applied to produce, meat, or the products sold by weight, volume, or some other unit of measurement. In some instances, products may be offered for sale at a certain price at limit of N per customer. Accordingly, where a third party promotion imposes such a limit, this limit may likewise be imposed when assigning credits. For example, where a third party price is offered only for N items and a customer buys M items, M being greater than N, the customer may be assigned a credit based on the difference between the purchase price paid for N of the M items and the third party price. For the remaining M-N items a credit may still be assigned if some other promotion or third party price is found to be lower than the purchase price paid.

Where a transaction received at step 90A is an online transaction, the third party pricing data may include prices corresponding to item identifiers as listed on an online interface (e.g. website) that is publically accessible. The third party prices evaluated may not be limited with respect to geography as for in-store transactions. However, third party prices may only be considered for online stores operating within the same country as that in which a transaction occurred that is being processed according to the method 90. The third party prices may be obtained by automated crawling of the third party web sites (e.g. using web crawlers or web bots). The third party prices may be obtained from an entity that gathers and publishes such information such as a SHOPZILLA.COM, the GOOGLE shopping API (application programming interface), or some other service. In some embodiments, not all third party online prices may be used according to the methods described herein. For example, AMAZON sells products to consumers through its website and also allows others to market products on the site through the AMAZON MARKETPLACE. In some embodiments, third party prices for products offered by outside entities on a third party's website may be excluded from comparison according to the methods described herein.

Inasmuch as third party online prices are more readily retrieved, the third party online pricing data may updated more frequently than in-store pricing data. For example, third party online pricing data may be retrieved once a day, once an hour or M hours (M<24), or some other period.

The method 90 may further include, for each item identifier of some or all of the item identifiers of the transaction record determining 90D a price difference between the lowest price found for the each item identifier in the third party pricing data. A credit for the transaction record according to the price differences determined at step 90D may then be determined 90E. For example, a credit equal to Pₜ−P₃ may be assigned for each item identifier for which Pₜ−P₃ is a positive number, where to Pₜ is the price paid as indicated by the transaction record and P₃ is the lowest corresponding third party price identified at step 90C for the item identifier.

The sum of the credits for each item identifier as determined may then be assigned to the user associated with the transaction record, such as by assigning a credit equal to the sum of the credits to an account associated with a same user identifier as included in the transaction record. For example, in some embodiments, the method 90 may include assigning 90F a credit, such as by generating a gift card, gift code, coupon, or some other data used to uniquely identify an account to which the credit was assigned or to represent the value of the credit. In some embodiments, the credit may be assigned to a debit card account. For example, a debit card having a checking account associated therewith or used exclusively by means of a debit card. For example, an AM-EX BLUEBIRD account provided by cooperation between WAL-MART and AMERICAN EXPRESS. The credit may also be multiplied by some multiplier greater than one, such as two, and the result of the multiplication assigned to the account of a user. In some embodiments, a user may be presented a choice between 1) a gift card or code or other assignment of credit to the user and 2) assignment of a credit to a debit card after applying some multiple. In some embodiments, a credit may be assigned in the form of a simple credit, gift card, or gift code by default.

The method 90 may further include redeeming 90H the credit. The credit may be redeemed in any manner known in the art. For example, a code may be transmitted to the user. The code may then be presented at the sale terminal 16. The code may be input to the sale terminal 16 that either independently validates the code or transmits it to the server system 102 a. Upon determining that the code is valid, such as by receiving a response from the server system indicating that it is valid, the sale terminal 16 may apply the corresponding credit to a transaction. The code may include text (letters, numbers, other typographic symbols), an optical code (bar code, quick response (QR) code, or the like). In some embodiments, the server system 14 may invoke mailing of a gift card to the customer or crediting of an account of the customer that has a card with a magnetic strip encoding an account identifier (e.g. debit card).

In some of the methods contemplated in the present application, credits assigned according to the method 90 for an online transaction may be redeemed to pay for an in-store transaction. Likewise, credits assigned for an in-store transaction may be redeemed to pay for an online transaction. Accordingly, as noted above, both an in-store sale terminal 16 and an online transaction processing sale terminal 16 may access the same redemption module 72 or operate with respect to the same set of data indicating the state of funds associated with a particular gift card, gift code, user account, or other account.

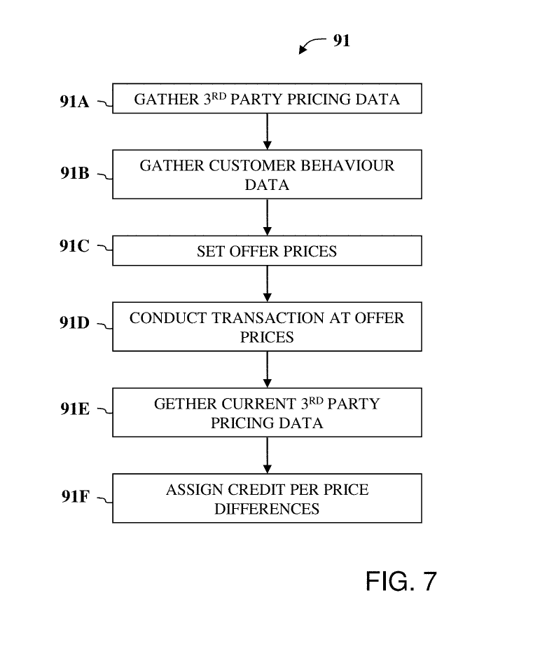

Referring to FIG. 7, a method 91 may be used to both set an offer price for an item and provide credits for price differences according to the methods described herein. The method 91 is particularly useful with respect to pricing data for products offered online. The method 91 may include gathering 91A third party pricing data. Gathering third party pricing data may be performed in the same manner as for the method 90, e.g. with a web crawler or from a data gathering entity. The pricing data may be gathered 91A for a window preceding a transaction, e.g. be data valid prior to a transaction being concluded.

The method 91 may further include gathering 91B customer behavior data with respect to the item and setting 91C an offer price based on the gathered 91A third party pricing data and the gathered 91B customer behavior data. For example, a method 92 of setting 91C an offer price is disclosed below.

The method 91 may further include conducting 91D an online transaction in which the item is sold at the offer price, though other discounts, promo codes, or other modifications to the offer price may be applied at the time of checkout as known in the art.

The method 91 may further include gathering 91E current third party pricing data. The third party pricing data gathered at step 91E may be gathered in a second window different from a second window at step 91A, though the first and second windows may overlap. In some embodiments, the second window may start where the first window begins, i.e. be performed with respect to pricing data that was not considered when setting the offer price. In other embodiments, the second window may be a time window including the transaction date and extending before and/or after the transaction date. The second window may therefore simply be a window in which third party pricing data is obtained for purposes of assigning credits according to the methods disclosed herein.

The method 91 may further include assigning 91F a credit for the item of the transaction conducted at step 91D according to price differences between the price paid for the item and a lowest third party price, such as in a same manner as for the method 90.

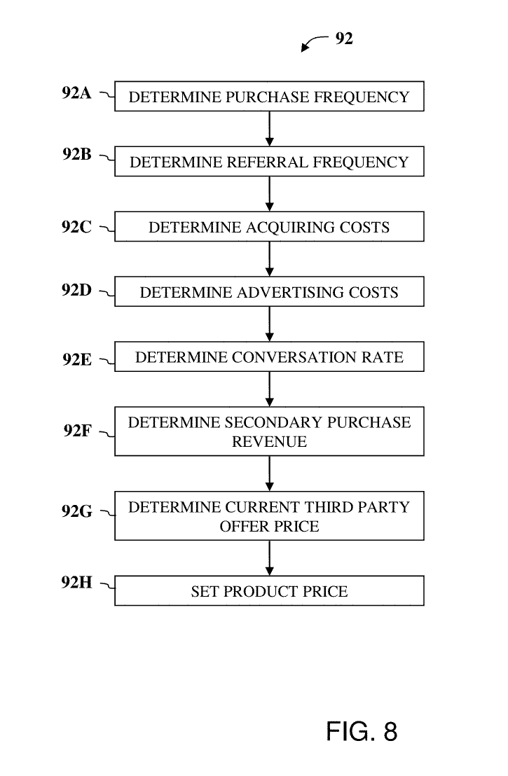

FIG. 8 illustrates a method 92 for setting a price of one or more item identifiers. The method 92 may be performed periodically in order to ensure that pricing for each of the one or more item identifiers is competitive. For example, the method 92 may include determining a purchase frequency for each item identifier of the one or more item identifiers 92A. A purchase frequency may be expressed in terms of purchases per unit time in a window, such as N hours (N being less than 24) preceding performance of the method 92, N days, N weeks, or some other period. In some embodiments, the method 92 may only be executed with respect to those items that are popular, i.e. have a purchase frequency above some threshold or are the top N, N being some integer, products with the highest purchase frequency. Accordingly, the remaining steps of the method 92 may be executed with respect to items having a purchase frequency meeting this threshold condition. Those items that do not meet this condition may be priced based on acquisition costs and other factors in any manner known in the art.

The method 92 may include determining 92B a referral frequency for the one or more item identifiers. A referral frequency for an item may include a number requests for content relating to an item (“hits”) initiated by selecting a link in search results, either as presented by a third party search engine or searching a website hosted by the retailer performing the method 92. The frequency may be expressed as hits per unit time within a window, which may be any of the windows noted above for the purchase frequency.

The method 92 may include determining 92C acquiring costs for the one or more items. Acquiring cost may be costs to the entity performing the method 92. The acquiring cost may also be general, e.g. published or universal, costs for certain products where these are known. Acquiring cost may be the costs of the entity performing the method 92 to acquire a unit of a product corresponding to the item identifier. For example, where a product is bought at price X for a lot of N instances of the product, an instance of the product being the smallest unit that can be purchased at a time, then the per unit price is X/N. Other acquiring costs, or estimates thereof, such as shipping costs, taxes, financing costs, stocking costs, may also be taken into account in determining the acquiring cost of an individual instances of an item or lot of items. Determining 92C the acquiring cost for an item identifier may include calculating one or more statistical values based on the acquiring cost for the item over time, such as within a window of time. For example, for a given transaction date, the acquiring costs may be determined on different days within some or all a week, two week period, month period, or some other period of time. For example, for each day in a given period, the acquiring cost on that day may be calculated. These values may then be used as a data set to compute a statistical values for the given period. In some instances, acquiring costs do not change day to day such that the acquiring costs may be measured every N days, or on one or more days of a week, within the given period. Statistical values may include such values as a minimum acquiring cost, maximum acquiring cost, average acquiring cost, and/or a variance of the acquiring costs of the data set.

As for other methods described herein, the acquiring costs may be calculated for a given geographic region, e.g. a region including a location at which a transaction being analyzed according to the methods disclosed herein was concluded. For example, acquiring costs for one or more stores within a radius R from the transaction location may be characterized 92C. Alternatively, acquiring costs for the closest store, or closest M stores (M being 2 or more) may be characterized.

The method 92 may further include determining 92D advertising costs for the one or more item identifiers. Advertising costs may be advertising costs associated specifically to a specific item identifier, e.g. targeted advertising referencing the item identifier (e.g. email advertisements), web ads referencing the item identifier, sponsored links in search results referencing the item identifier, or other advertising costs. In some embodiments, general advertising costs may also be prorated to individual item identifiers.

The method 92 may include determining 92E a conversion rate for each of the one or more item identifiers. A conversion rate may be a ratio of purchases within some time window to some other value. For example, the conversion ratio may be the ratio of a number of purchases of an item identifier within a window and a number of hits on a web page for the item identifier within the window. The conversion ratio may be the ratio of a number of purchases of an item identifier within a window and a number of referrals for the item identifier within the window.

The method 92 may include determining 92F secondary purchase revenue for the one or more item identifiers. Secondary purchase for an item identifier may be revenue from other products purchased in transactions for the item identifier, such as transactions within some window prior to the performance of the method 92, e.g. one month, one week, or some other period. Secondary purchase revenue may be expressed as an average secondary revenue per transaction including the item identifier or as an average secondary revenue per unit time for the item identifier.

The method 92 may further include determining 92G current third party prices for the one or more item identifiers. The current third party price for an item identifier may be a lowest or average third party price for the item identifier among the third party data valid in some window preceding performance of the method 92, such as a one week, one month, or some other window preceding performance of the method 92.

The method 92 may further include setting 92H prices for the one or more item identifiers based on the determinations made at steps 92A-92G. For example, some or all of the determinations made at steps 92A-92G may be input to a function that provides as an output an offer price. For example, where revenue from secondary purchases is high, then the offer price may be set at or below the acquiring cost. For example, an offer price for an item identifier may be set equal to the third party price for the item identifier less some percentage, e.g. 10 percent or some other percentage, of the secondary revenue for the item identifier. The amount by which an offer price is reduced below acquiring costs, or some mark up from the acquiring costs, may increase with increase in some or all of the purchase frequency, referral frequency, conversion rate, and secondary purchase revenue. The purchase frequency, referral frequency, conversion rate, and secondary purchase revenue may be normalized, scaled, and/or weighted to obtain processed versions of these values. The processed versions may then be summed to determine a discount to apply to the acquiring cost, acquiring cost plus some mark up, or the third party offer price. In some embodiments, trends in any of the values determined according to steps 92A-92G may be used to set a price. For example, a product that has quickly increasing popularity may be discounted in order to drive traffic to an ecommerce cite.

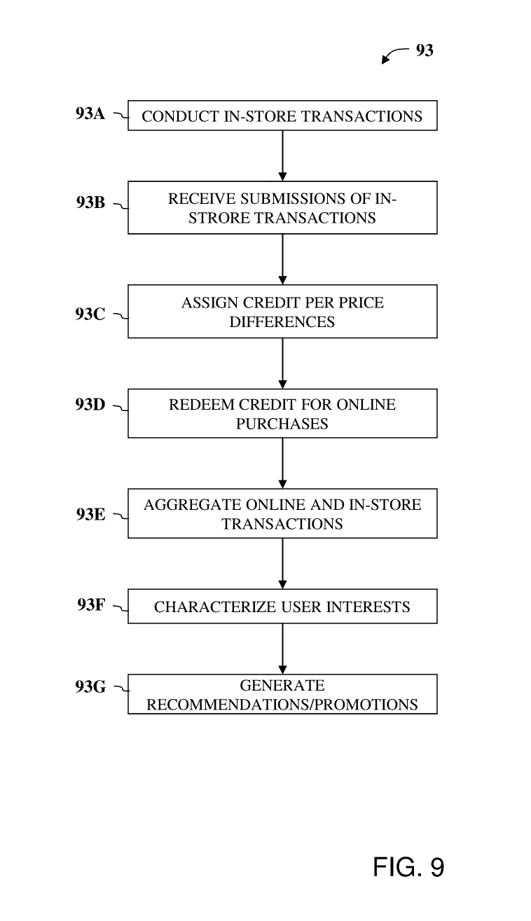

Referring to FIG. 9, the illustrated method 93 may be used to relate one or more online purchases to one or more in-store purchases, i.e. determine that online purchases and in-store purchases were made by the same customer without explicit information establishing the association such as by the user using a common user identifier for both types of transactions.

The method 93 may include conducting 93A an in-store transaction or a plurality of in-store purchases. Conducting an in-store purchase may include receiving information that is common to a plurality of in-store purchases for a user, such as a credit card number used for a plurality of purchases, loyalty card number, phone number, user identifier, or some other item of identifying information. Conducting an in-store transaction may further include generating a transaction record describing the transaction. The transaction record may include some or all of the items noted above as possibly included in a transaction record.

The method 93 may further include receiving 93B submission of one or more of the in-store transactions for review and assigning 93C credit according to price differences. Steps 93B and 93D may be performed according to the method 90 of FIG. 6. The credit assigned 93C may be redeemed 93D to completely or partially pay for an online purchase. Redeeming the credit may likewise be performed in a same manner as described hereinabove with respect to the method 90. As part of redeeming 93D the credit, the user may enter a user identifier in order to log in to an account of the customer and conduct the transaction using that account. In some embodiments, the user account and user identifier may not correspond to the identifying information for the in-store transaction at step 93A. In some embodiments, the identifying information may be identical but be stored in separate domains or databases such that online transactions of a user are not readily relatable to in-store transactions of the same user.

The method 93 may further include using the fact of the redeeming of the credit to determine that the in-store transaction and the online purchase were conducted by or for the same user. In particular, the credit or code may be associated with an account of the user in which in-store transactions are associated. By entering or using the credit or code for the online transaction, the account with which it is associated may be obtained thereby relating the online and in-store transactions. The online and in-store transactions may then be aggregated 93E. In particular, purchases of a user may be used to characterize the interests of the user and used to determine recommendations, promotions, substitutions, and other offers targeted to the user. Accordingly, by aggregating the online and in-store transactions, the amount of data regarding a user is expanded. In particular, the types of items purchased in-store often are not bought online. Accordingly, attempting to characterize a user's consumption behavior based only on online purchases may be inadequate.

The method 93 may further include characterizing 93F a user's interests based on the aggregated transactions and generating 93G recommendations, promotions, and other targeted offers and information to the user based on the aggregated transactions. The methods by which a user's interests may be obtained and promotions generated may be according to any approach known in the art for profiling a customer based on past purchases.

Although method 93 is described above as a process wherein a credit assigned for an in-store transaction may be applied to an online transactions, the opposite may be true. That is, a credit assigned for an online transaction according to the methods described herein may be applied to an in-store transaction thereby establishing an association between the online and in-store transactions. The aggregate online and in-store transactions may then be aggregated and processed according to the method 91.

### Return Processing

In some embodiments, for a transaction record for which credits have been assigned, a return record may be associated therewith indicating that the items of the transaction were returned and a refund issued for the original purchase prices of the items. An updated transaction record indicating that the items were purchased at a reduced price, i.e. the updated price of an item may be the purchase price of each item less a credit assigned for each item. When issuing returns, the updated transaction record may then be used to determine an amount of a refund due.

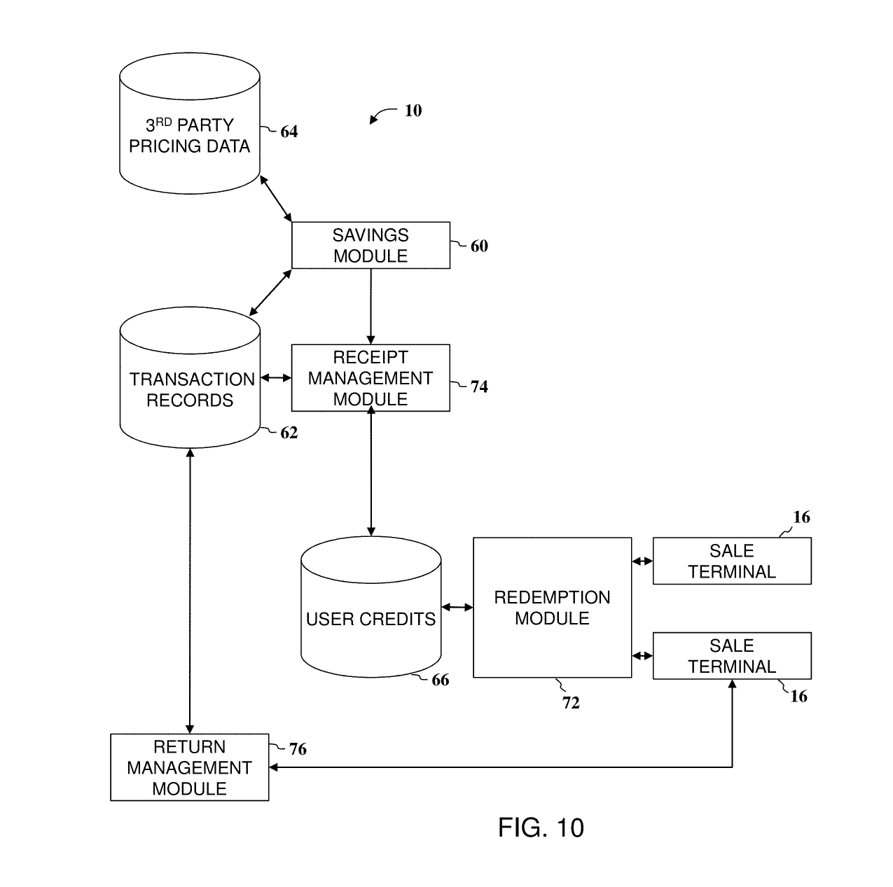

Referring to FIG. 10, the savings module 60 may ingest data such as a transaction record (e.g. receipt) from among user transaction records 62. The savings module 60 may further take as input third party pricing data 64. The third party pricing data 64 may be pricing data from different entities than the entity that conducted the transaction represented by the transaction record. The third party pricing data 64 may be data that reflecting prices offered on a same day as a date on which the transaction represented by the transaction record took place. The savings module 60 compares the prices of items in the transaction record to prices for corresponding items in the third party pricing data 64. The savings module then assigns user credits 66 to an account of the user associated with the transaction or otherwise attributes credits 66 to the user.

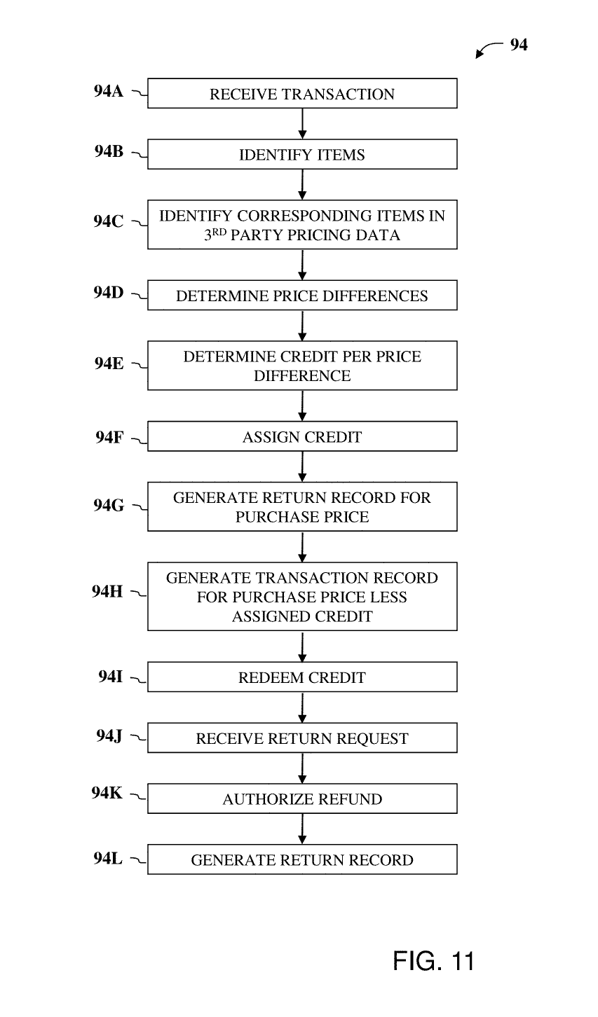

A receipt management module 74 may adjust the transaction records 62 in response to the assigning of user credits 66, as described in greater detail with respect to the method 94 of FIG. 11 described below. A return management module 74 may receive and process requests for refunds from the sale terminal 16. A return management module 76 may process requests for refunds upon returning of an item. The return management module 76 may access and modify the transaction records 62 based on returns authorized and processed as described below with respect to the method 94 of FIG. 11, below.

A redemption module 72 may interact with one or more sale terminals 16 to apply the credits to subsequent transactions. For example, the redemption module 72 may issue a gift card, code for a gift card, assign credits to a gift card, or otherwise provide a message containing information that a user may use at a sale terminal in order to apply the credits to a transaction. The redemption module 72 may interact with the sale terminal 26 in order to validate a gift card, code, or other representation of credits presented at the sale terminal when processing payment for a transaction. For example, a cashier or device may receive the code, scan the gift card, swipe the gift card through a magnetic reader, or otherwise input a representation of the gift card into the sale terminal 16. The sale terminal may then transmit this information, or a representation thereof, to the redemption module 72. If the transmitted information is valid, the redemption module 72 may transmit authorization to the sale terminal to apply corresponding credits to the transaction. Otherwise, the redemption module 72 may transmit a rejection of the transmitted information and the sale terminal will not apply any corresponding credits to the transaction.

FIG. 11 illustrates an example of a method 94 that may be used to provide credits to users based on price difference between a price paid and third party prices. The method 94 may include receiving 94A a record of a transaction. A record of a transaction may include such data as a date of the transaction, a location where the transaction occurred, an identifier of the POS at which the transaction occurred, an identifier of the customer that was a party to the transaction, and other information. The transaction record may further include various <product, price> entries that list a product identifier and a price paid for the product corresponding to that product identifier. Other data may include taxes paid for the entire transaction and/or for specific item identifiers. Any discounts due to coupons or price matching may also be noted for each item identifier for which such price adjustments were applied. The transaction record may be transmitted from a sale terminal 16 to a server system 14. The transaction record may additionally or alternatively transmitted to a customer in electronic form and/or by means of a printed copy. The transaction record may be associated by the server system with the user data of a user with whom the transaction was conducted, such as using a credit card number or identifier supplied to the sale terminal at the time of concluding the transaction and included in, or associated with, the transaction record. For example, the transaction record may be in the form of an electronic receipt provided to the customer.

The step of receiving 94A the receipt may include receiving a transaction identifier from a user computing device 22 through a portal such as a website hosted by the server system 14. The transaction identifier may uniquely identify the transaction record and may be printed on a paper receipt to enable the customer to take advantage of the methods disclosed herein and/or for other purposes. Receiving 94A the receipt may include receiving, by the server system 14, a selection of the transaction in a listing of transactions presented in a portal provided by the server system 14 or by an application for viewing receipts stored locally on a user computing device 22. For example, transactions may be made available to a user in the form of electronic receipts stored in an account of a user and recording transactions conducted by the user. In some embodiments, all transactions of a user may be submitted for review according to the method 94. For example, where a user has installed a mobile application for interfacing with the server system 14, all transactions of a user may be automatically submitted for review according to the method 94. In some embodiments, transactions may be transmitted to the server system by 1) the user scanning a bar code or other optical code printed on a receipt with a user computing device 22, 2) the user device 22 transmitting some representation of the optical code to the server system 14 a and 3) the server system 14 identifying a transaction record corresponding to the transmitted representation of the optical code.

In some embodiments, the server system 14 may limit a number of receipts that may be submitted by a customer, e.g. for a specific user account. For example, N transactions may be process per week for the customer. In some embodiments, multiple limits on receipts for multiple corresponding time period may be imposed. For example, only N transactions per week or M transactions per month may be allowed by the server system 14 to be processed according to the methods described herein for purposes of determining a credit based on price differences.

The method 94 may further include identifying 94B from the received transaction record the item identifiers of items purchased as part of the transaction and the price for each item. For example, fields of the form <item identifier, price paid> may be filled with the item identifier and purchase price for some or all items listed as having been purchased in a transaction record. The item identifier may be a proprietary product identifier for a product catalog of a merchant or a universal identifier (e.g. a universal product code (UPC)).

For some or all of the identified 94B items, corresponding items may be identified in third party pricing data. In particular, a lowest price for each item identifier may be identified among the third party pricing data. As noted above, pricing data may include advertised prices exclusively. Pricing data may also include the sale price for some items regardless of whether that price is advertised. Pricing data searched to identify corresponding third party prices may be limited to pricing data for retail stores within a threshold proximity of the POS or retail location identified by the transaction record that is the subject of the method 94. For example, the threshold may reference a geographical or political region (neighborhood, city, county, state, etc.) or may specify a circular area having a radius R with respect to the POS or store location indicated in the transaction record.

Identifying the lowest price among the third party pricing data for each item identifier of at least a portion of the item identifiers in a transaction may include determining a per-unit cost for corresponding items in the third party pricing data. For example, if a product corresponding to an item identifier is offered for sale as a buy N at price P per unit and get M free, then the price of an individual instance of that product may be prorated to be (N/(N+M))*P. This prorated price may then be used for purposes of determining whether a price is the lowest as compared to prices offered for that product by other entities and for comparison with the purchase price for the corresponding item identifier in the transaction record. In some instances, where items are sold by a unit of measure, such as weight, the cost per unit weight for an item may also be determined form the third party pricing data. For example, this approach may be applied to produce, meat, or the products sold by weight, volume, or some other unit of measurement. In some instances, products may be offered for sale at a certain price at limit of N per customer. Accordingly, where a third party promotion imposes such a limit, this limit may likewise be imposed when assigning credits. For example, where a third party price is offered only for N items and a customer buys M items, M being greater than N, the customer may be assigned a credit based on the difference between the purchase price paid for N of the M items and the third party price. For the remaining M−N items a credit may still be assigned if some other promotion or third party price is found to be lower than the purchase price paid.

The method 94 may further include, for each item identifier of some or all of the item identifiers of the transaction record determining 94D a price difference between the lowest price found for the each item identifier in the third party pricing data. A credit for the transaction record according to the price differences determined at step 408 may then be determined 94D. For example, a credit equal to Pₜ−P₃ may be assigned for each item identifier for which Pₜ−P₃ is a positive number, where to Pₜ is the price paid as indicated by the transaction record and P₃ is the lowest corresponding third party price identified at step 94C for the item identifier.

The sum of the credits for each item identifier as determined 94E may then be assigned to the user associated with the transaction record, such as by assigning a credit equal to the sum of the credits to an account associated with a same user identifier as included in the transaction record.

In some embodiments, the method 94 may include assigning 94F a credit, such as by generating a gift card, gift code, coupon, or some other data used to uniquely identify an account to which the credit was assigned or to represent the value of the credit. In some embodiments, the credit may be assigned to a debit card account. For example, a debit card having a checking account associated therewith or used exclusively by means of a debit card. For example, an AM-EX BLUEBIRD account provided by cooperation between WAL-MART and AMERICAN EXPRESS. The credit may also be multiplied by some multiplier greater than one, such as two, and the result of the multiplication assigned to the account of a user. In some embodiments, a user may be presented a choice between 1) a gift card or code or other assignment of credit to the user and 2) assignment of a credit to a debit card after applying some multiple. In some embodiments, a credit may be assigned in the form of a simple credit, gift card, or gift code by default.

In some embodiments, credits assigned according to the methods described herein may be transmitted for display in a portal with listing credits for various transactions. Upon selecting of a transaction a portal may display information about a specific transaction and the credits assigned based thereon according to the methods described herein. In some embodiments, a portal may be displayed summarizing information for a specific transaction, the portal including a map displaying the location of third party stores at which a lower price was found and for which a credit was assigned according to the methods disclosed herein.

In some embodiments, the method 94 may include generating 94G a return record for the purchase price for all items for which a lower price was found among third party pricing data and for which a credit was assigned 94F. The method 94 may further include generating 94H an updated transaction recording the items for which a lower price was found and credits assigned as having been purchased for an updated purchase price. The updated purchase price may be the original purchase price reduced by the amount of credit assigned based on a difference between the original purchase price and a lower third part price for that item. In some embodiments, steps 94G and 94H may be performed by the receipt management module 74 in response to detecting assignment of credit by the savings module 60.[0054]

For example, for a given transaction record, a total credit including a sum of credits CA, CB, and CC may be assigned for one or more item identifiers A, B, and C of the transaction record having prices paid PA, PB, and PC, respectively. CA, CB, and CC may be equal to, or determined based on, a difference between PA, PB, and PC and corresponding third party prices TA, TB, TC, respectively. The transaction records 62 may be modified by generating 422 a return record indicating that products A, B, and C were returned and a refund of the purchase prices PA, PB, and PC generated. Another transaction record may then be generated indicating that products A, B, and C were purchased and the purchase price for each was PA−CA, PB−CB, and PC−CC, respectively.

The method 94 may further include redeeming 94I the credit. The credit may be redeemed in any manner known in the art. For example, a code may be transmitted to the user. The code may then be presented at the sale terminal. The code may be input to the sale terminal that either independently validates the code or transmits it to the server system 14, such as to the redemption module 72. Upon determining that the code is valid, such as by receiving a response from the server system 14 (e.g. redemption module 72) indicating that it is valid, the sale terminal may apply the corresponding credit to a transaction. The code may include text (letters, numbers, other typographic symbols), an optical code (bar code, quick response (QR) code, or the like). In some embodiments, the server system 14 may invoke mailing of a gift card to the customer or crediting of an account of the customer that has a card with a magnetic strip encoding an account identifier (e.g. debit card).

The method 94 may include receiving 94J a return request, such as by a return management module 76. The return request may be received by the server system 14 from a sale terminal 16 at which a customer has attempted to return an item. The return request may include a transaction identifier and identify one or more items from a transaction that customer is returning. The return request may further include one or both of an identifier of a store at which the transaction occurred; a date and time when the transaction occurred; universal product code (UPC) or other identifier for returned items; a quantity of items to be returned; a weight of items to be returned; pricing information for the items to be returned; and a store authorization code. The transaction identifier may correspond to a specific transaction record 14. The method 94 may further include evaluating the request and if the evaluation indicates that a refund is appropriate, authorizing 94K a refund. Authorizing 94K the refund may include transmitting an indicator that the refund as well as an amount that is authorized to be refunded, which may be different than the price on a customer's receipt presented at the sale terminal due to credits previously assigned.

For example, if a credit has been assigned and a return record and updated transaction record have been generated 94H, 94I, then the method 94 may include authorizing 94K, such as by return management module 76, a refund for the purchase price in the updated transaction record generated at step 94I, i.e. the original price for an item for which a refund is requested less any credit assigned for that item. The server system 14 a may also include in generating 94L a return record indicating that refunds have been issued for the items referenced in the return request. The return record may be linked to or included in the transaction record for the original transaction evaluated at step 94A. In this manner the server system 14 may determine that a refund has already been issued for an item referenced in a request, in which case the server system may deny a request for a refund. In some embodiments, a return request may be denied if any of the information in the return request does not match corresponding information in a transaction record 62 for which the return request is requesting a refund one or more items. In some embodiments, a store manager may have discretion to override a rejection of a return request that has been denied for any of the foregoing reasons, such as by inputting an authorization code that may be transmitted with a return request to the server system 14.

### Fraud Protection

In some embodiments, recent purchasing activity may be compared to historical purchasing activity of a customer in order to detect potentially fraudulent transactions. For example, if recent activity varies from historical activity in one or more aspects, a flag may be set for a transaction. Flagged transactions may be evaluated automatically or by a person in order to either clear the flag or determine that the transaction does indicate fraud such that credits will not be assigned for price differences.

A flag may be set if a frequency with which a user generates transactions or submits transactions for review is significantly greater than a frequency indicated by historical shopping history. A flag may be set if a frequency with which a user generates transactions or submits transactions for review is significantly greater than a frequency indicated by historical shopping history.

A flag may be set if recent return activity of a customer is significantly greater than historic return activity. A flag may be set if an amount of a credit assigned based on a price differences for a transaction is significantly larger than a typical credit assigned for past transactions. A flag may be set if a category of goods for recent transactions does not belong to a category of goods purchased in historical transactions of a user. A flag may be set if timing (day of the week, time of day, etc.) of a recent transaction is different than for typical transactions of a user. A flag may be set if the computing device or other aspect of a networked connection between a user and a server system is different than for past transactions. A flag may be set if a location of a transaction is a threshold amount away from a typical location of past transactions. A flag may be set if a price of the transaction more than a threshold amount greater than a typical price of past transactions.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

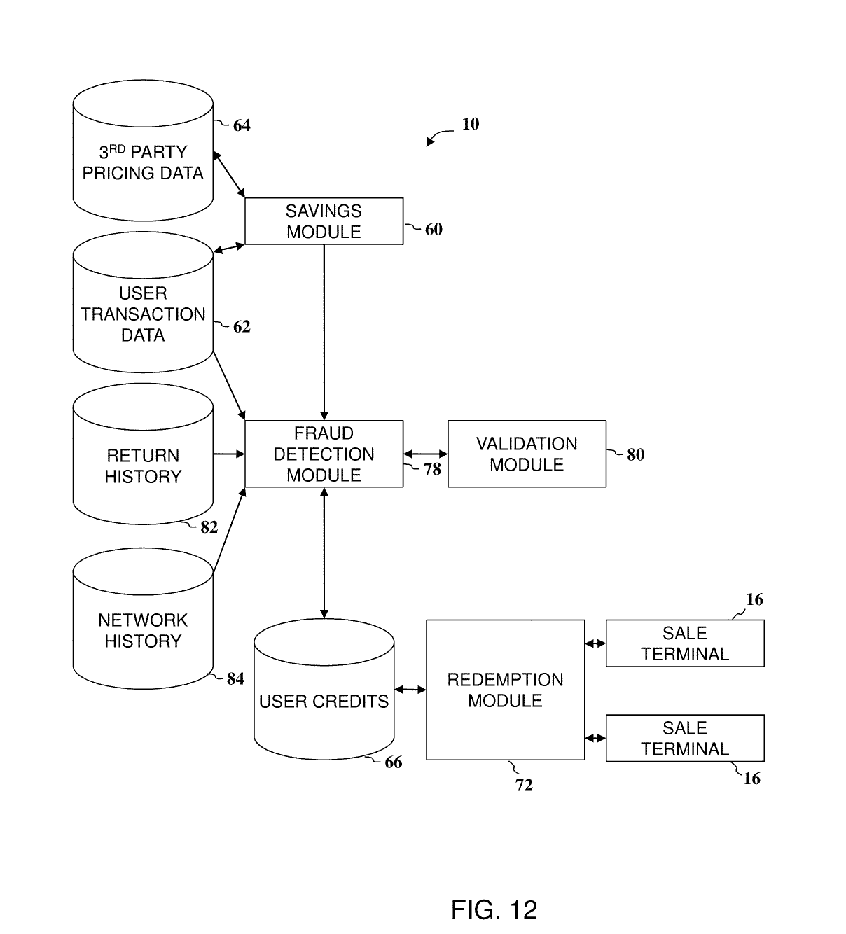

Referring to FIG. 12, the savings module 60 may ingest data such as a transaction record (e.g. receipt) from among user transaction data 14. The savings module 60 may further take as input third party pricing data 64. The third party pricing data 64 may be pricing data from different entities than the entity that conducted the transaction represented by the transaction record. The third party pricing data 64 may be data that reflecting prices offered on a same day as a date on which the transaction represented by the transaction record took place. The savings module 60 compares the prices of items in the transaction record to prices for corresponding items in the third party pricing data 64. The savings module then assigns user credits 66 to an account of the user associated with the transaction or otherwise attributes credits 66 to the user.

A fraud detection module 78 may receive a credit as determined by the savings module 60 and determine whether the transaction on which it is based is potentially fraudulent. The fraud detection module 78 may also take as inputs user transaction data 62, return history 82, network history 82, as well as past credits 62 assigned to the user account with which the transaction is associated. In some embodiments, the fraud detection module 78 may also attempt to detect multiple accounts from the same user. For example, when a user creates an account, a validation message (SMS text, email, etc.) may be transmitted using contact information provided by the user when creating the account. If the user does not respond (e.g. send a reply text or email) to the validation message, the account will not be created. Likewise, if a notification transmitted during processing of a transaction according to the methods disclosed herein is found to be undeliverable, the transaction may be flagged as fraudulent or potentially fraudulent.

A validation module 80 may receive flagged transactions from the fraud detection module 78 that the fraud detection module 78 determines to be potentially fraudulent. The validation module 80 may present a report or some other visual representation of factors determined by the fraud detection module 78 to indicate fraudulent activity. The validation module 80 may further define an interface in which a representative of a retailer may determine whether the transaction should be deemed fraudulent or not. The validation module 304 may receive this input and the fraud detection module may take appropriate action based on the input from the validation module 304.

A redemption module 72 may interact with one or more sale terminals 16 to apply the credits to subsequent transactions. For example, the redemption module 72 may issue a gift card, code for a gift card, assign credits to a gift card, or otherwise provide a message containing information that a user may use at a sale terminal 16 in order to apply the credits to a transaction. The redemption module 72 may interact with the sale terminal 16 in order to validate a gift card, code, or other representation of credits presented at the sale terminal when processing payment for a transaction. For example, a cashier or device may receive the code, scan the gift card, swipe the gift card through a magnetic reader, or otherwise input a representation of the gift card into the sale terminal 16. The sale terminal 16 may then transmit this information, or a representation thereof, to the redemption module 72. If the transmitted information is valid, the redemption module 72 may transmit authorization to the sale terminal to apply corresponding credits to the transaction. Otherwise, the redemption module 72 may transmit a rejection of the transmitted information and the sale terminal 16 will not apply any corresponding credits to the transaction.

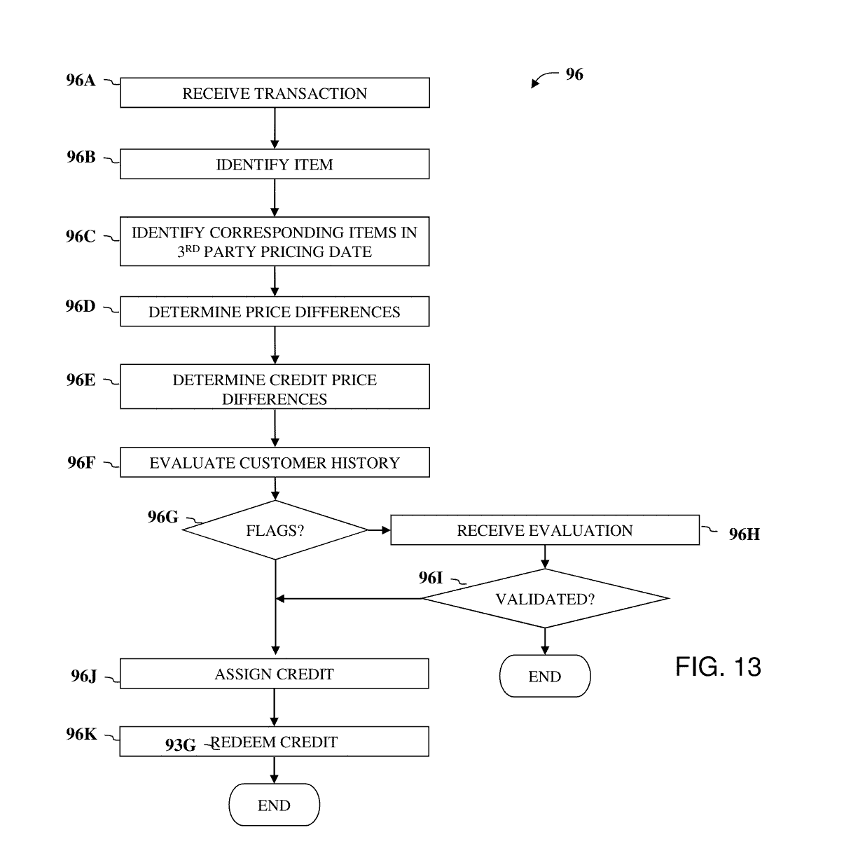

FIG. 13 illustrates an example of a method 96 that may be used to provide credits to users based on price difference between a price paid and third party prices. The method 96 may include receiving 96A a record of a transaction. A record of a transaction may include such data as a date of the transaction, a location where the transaction occurred, an identifier of the sale terminal at which the transaction occurred, an identifier of the customer that was a party to the transaction, and other information. The transaction record may further include various <product, price> entries that list a product identifier and a price paid for the product corresponding to that product identifier. Other data may include taxes paid for the entire transaction and/or for specific item identifiers. Any discounts due to coupons or price matching may also be noted for each item identifier for which such price adjustments were applied. The transaction record may be transmitted from a sale terminal 16 to a server system 14. The transaction record may additionally or alternatively transmitted to a customer in electronic form and/or by means of a printed copy. The transaction record may be associated by the server system with the user data 20 of a user with whom the transaction was conducted, such as using a credit card number or identifier supplied to the sale terminal at the time of concluding the transaction and included in, or associated with, the transaction record. For example, the transaction record may be in the form of an electronic receipt provided to the customer.

The step of receiving 96A the receipt may include receiving a transaction identifier from a user computing device 22 through a portal such as a website hosted by the server system 14. The transaction identifier may uniquely identify the transaction record and may be printed on a paper receipt to enable the customer to take advantage of the methods disclosed herein and/or for other purposes. Receiving 96A the receipt may include receiving, by the server system 14, a selection of the transaction in a listing of transactions presented in a portal provided by the server system 14 or by an application for viewing receipts stored locally on a user computing device 22. For example, transactions may be made available to a user in the form of electronic receipts stored in an account of a user and recording transactions conducted by the user. In some embodiments, all transactions of a user may be submitted for review according to the method 400. For example, where a user has installed a mobile application for interfacing with the server system 14, all transactions of a user may be automatically submitted for review according to the method 96. In some embodiments, transactions may be transmitted to the server system by 1) the user scanning a bar code or other optical code printed on a receipt with a user device 108, 2) the user device 22 transmitting some representation of the optical code to the server system 102 a and 3) the server system 14 identifying a transaction record corresponding to the transmitted representation of the optical code.

In some embodiments, the server system 14 may limit a number of receipts that may be submitted by a customer, e.g. for a specific user account. For example, N transactions may be process per week for the customer. In some embodiments, multiple limits on receipts for multiple corresponding time period may be imposed. For example, only N transactions per week or M transactions per month may be allowed by the server system 14 to be processed according to the methods described herein for purposes of determining a credit based on price differences.

The method 96 may further include identifying 96B from the received transaction record the item identifiers of items purchased as part of the transaction and the price for each item. For example, fields of the form <item identifier, price paid> may be filled with the item identifier and purchase price for some or all items listed as having been purchased in a transaction record. The item identifier may be a proprietary product identifier for a product catalog of a merchant or a universal identifier (e.g. a universal product code (UPC)).

For some or all of the identified 96B items, corresponding items may be identified in third party pricing data. In particular, a lowest price for each item identifier may be identified among the third party pricing data. As noted above, pricing data may include advertised prices exclusively. Pricing data may also include the sale price for some items regardless of whether that price is advertised. Pricing data searched to identify corresponding third party prices may be limited to pricing data for retail stores within a threshold proximity of the POS or retail location identified by the transaction record that is the subject of the method 96. For example, the threshold may reference a geographical or political region (neighborhood, city, county, state, etc.) or may specify a circular area having a radius R with respect to the POS or store location indicated in the transaction record.

Identifying the lowest price among the third party pricing data for each item identifier of at least a portion of the item identifiers in a transaction may include determining a per-unit cost for corresponding items in the third party pricing data. For example, if a product corresponding to an item identifier is offered for sale as a buy N at price P per unit and get M free, then the price of an individual instance of that product may be prorated to be (N/(N+M))*P. This prorated price may then be used for purposes of determining whether a price is the lowest as compared to prices offered for that product by other entities and for comparison with the purchase price for the corresponding item identifier in the transaction record. In some instances, where items are sold by a unit of measure, such as weight, the cost per unit weight for an item may also be determined form the third party pricing data. For example, this approach may be applied to produce, meat, or the products sold by weight, volume, or some other unit of measurement. In some instances, products may be offered for sale at a certain price at limit of N per customer. Accordingly, where a third party promotion imposes such a limit, this limit may likewise be imposed when assigning credits. For example, where a third party price is offered only for N items and a customer buys M items, M being greater than N, the customer may be assigned a credit based on the difference between the purchase price paid for N of the M items and the third party price. For the remaining M−N items a credit may still be assigned if some other promotion or third party price is found to be lower than the purchase price paid.

The method 96 may further include, for each item identifier of some or all of the item identifiers of the transaction record determining 96D a price difference between the lowest price found for the each item identifier in the third party pricing data. A credit for the transaction record according to the price differences determined at step 96D may then be determined 410. For example, a credit equal to Pₜ−P₃ may be assigned for each item identifier for which Pₜ−P₃ is a positive number, where to Pₜ is the price paid as indicated by the transaction record and P₃ is the lowest corresponding third party price identified at step 96C for the item identifier.

The sum of the credits for each item identifier as determined 96E may then be assigned to the user associated with the transaction record, such as by assigning a credit equal to the sum of the credits to an account associated with a same user identifier as included in the transaction record.

The method 96 may further include evaluating 96F a customer history with respect to the received 96A transaction or recent transactions of a user in order to determine if the received 96A transaction or recent transactions of a user indicate fraudulent activity. If flags are found 96G to have been generated based on the evaluation 96I, then the transaction and/or other data determined by the evaluation 96I to indicate fraudulent activity may be transmitted for display to a representative of a retailer. An evaluation of this information may then be received 96H. If the evaluation validates 96I the transaction (indicates it is not likely fraudulent), then steps 96J and 96K may be performed as described below. If not, then the method 400 may end, i.e. no credits are assigned 6J based on the transaction.

In some embodiment, the method 96 may include assigning 96J a credit, such as by generating a gift card, gift code, coupon, or some other data used to uniquely identify an account to which the credit was assigned or to represent the value of the credit. In some embodiments, credits assigned according to the methods described herein may be transmitted for display in a portal with listing credits for various transactions. Upon selecting of a transaction a portal may display information about a specific transaction and the credits assigned based thereon according to the methods described herein. In some embodiments, a portal may be displayed summarizing information for a specific transaction, the portal including a map displaying the location of third party stores at which a lower price was found and for which a credit was assigned according to the methods disclosed herein.

The method 96 may further include redeeming 96K the credit. The credit may be redeemed in any manner known in the art. For example, a code may be transmitted to the user. The code may then be presented at the sale terminal 16. The code may be input to the sale terminal that either independently validates the code or transmits it to the server system 14. Upon determining that the code is valid, such as by receiving a response from the server system indicating that it is valid, the sale terminal may apply the corresponding credit to a transaction. The code may include text (letters, numbers, other typographic symbols), an optical code (bar code, quick response (QR) code, or the like). In some embodiments, the server system 14 may invoke mailing of a gift card to the customer or crediting of an account of the customer that has a card with a magnetic strip encoding an account identifier (e.g. debit card).

In some embodiments, the credit may be assigned to a debit card account. For example, a debit card having a checking account associated therewith or used exclusively by means of a debit card. For example, an AM-EX BLUEBIRD account provided by cooperation between WAL-MART and AMERICAN EXPRESS. The credit may also be multiplied by some multiplier greater than one, such as two, and the result of the multiplication assigned to the account of a user. In some embodiments, a user may be presented a choice between 1) a gift card or code or other assignment of credit to the user and 2) assignment of a credit to a debit card after applying some multiple. In some embodiments, a credit may be assigned in the form of a simple credit, gift card, or gift code by default.

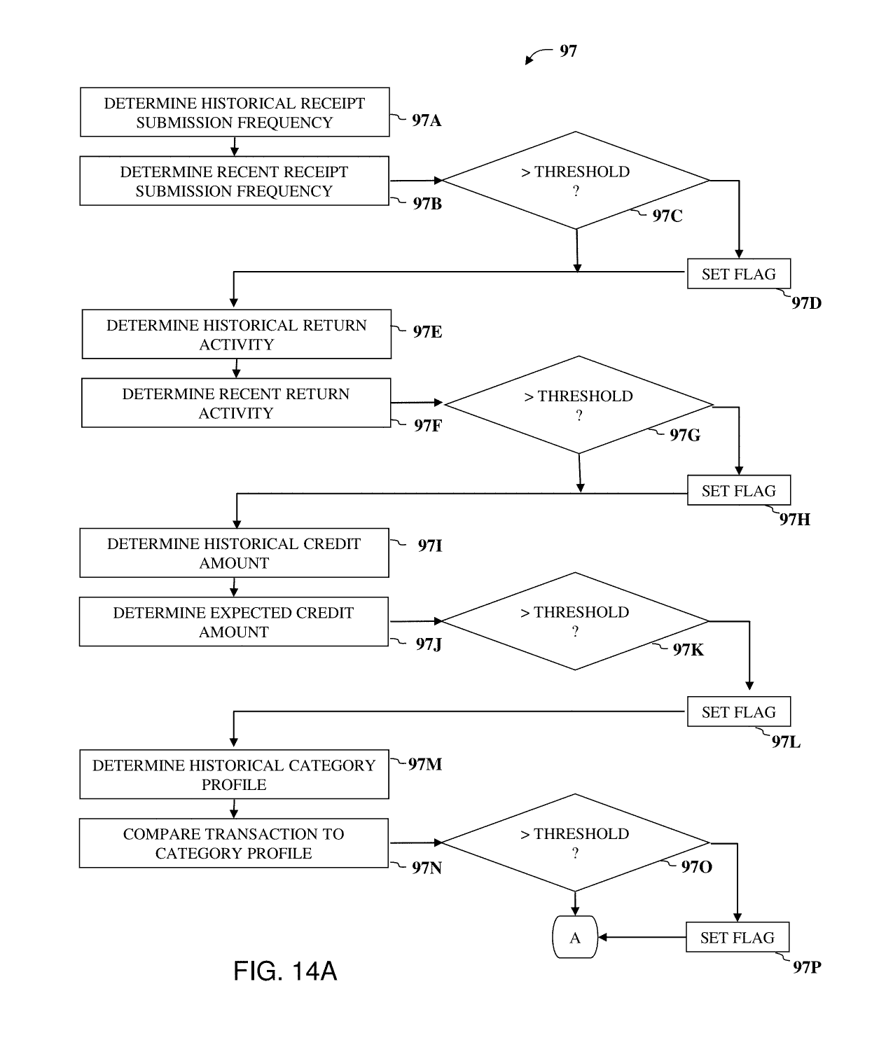

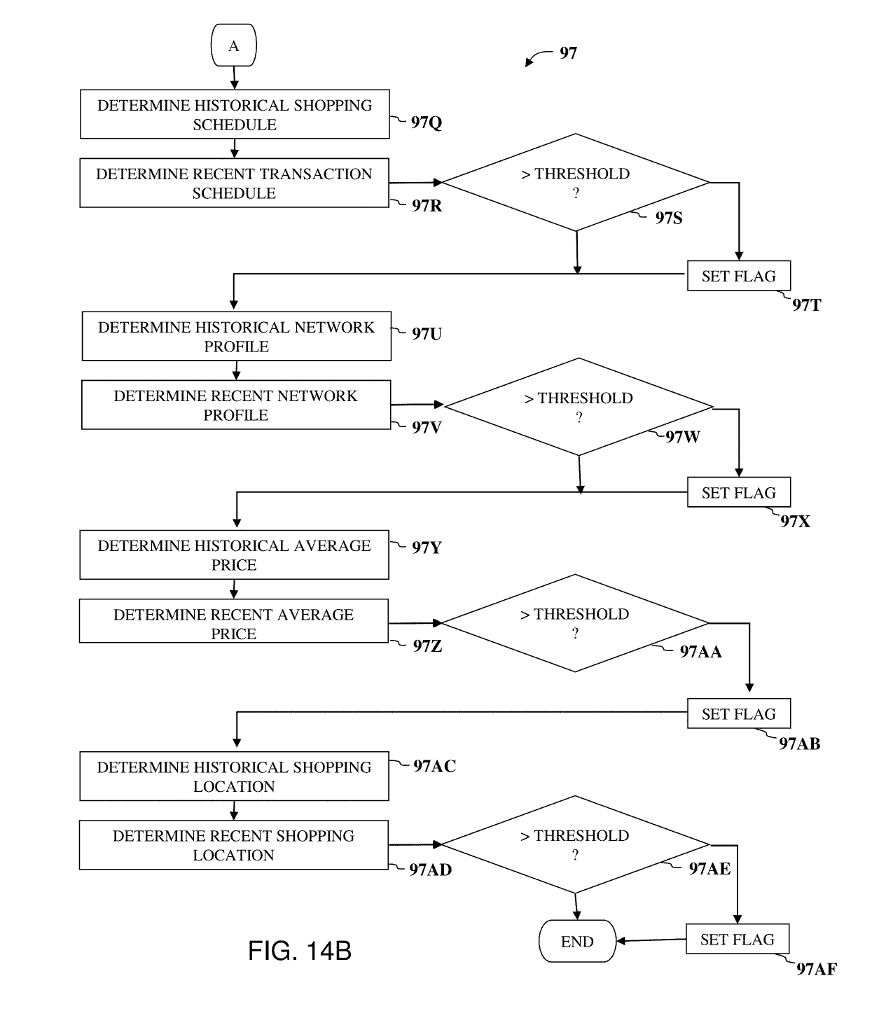

Referring to FIGS. 14A-14B, a method 97 may be executed to determine whether a transaction is likely fraudulent, e.g. identify potentially fraudulent transactions. The method 97 may be executed with respect to some or all of the user data 20 associated with a user account of a user identifier identifying the purchaser in a transaction record. For purposes of the method 97, “recent” may indicate occurrence within a window up until a date of a transaction being evaluated or the time at which a transaction occurs. For example, a window of one week, two weeks, one month, or some other length. For purposes of the method 97, “historical” may indicate occurrence within a window preceding the window defined as “recent.” The “historical” window may include all user activity preceding the “recent” window or may be limited to a finite length, e.g. three months, six months, a year, or some other time range, preceding the “recent” window. In some embodiments, the “historical” window is longer than the “recent” window, e.g. more than two times as long, more than 10 times as long, or some other multiple of the length of the “recent” window.

The method 500 may include determining 502 a historical receipt submission frequency for the user identifier and determining 504 a recent receipt submission frequency for the user identifier. Submission frequency may be defined as a number of receipts submitted for review according to the method 400 in a given window (recent or historical). In some embodiments, the method 400 is invoked upon request of a user, such as through a portal or other interface to the server system 102 a with respect to a transaction recorded in the user data 110 for a particular user identifier.

Submission frequency may be defined as an average, e.g. an average of X transactions per unit time submitted within a given window. The submission frequency may also take into account a purchase price of a transaction, e.g. an average of transactions worth Y dollars were submitted for the user identifier per unit time within the given window.

The difference between the recent submission frequency and the historical submission frequency may be evaluated with respect to a threshold condition. For example the threshold condition may include the following expression being true R−H>T or R>A*H, where R is the recent submission frequency, H is the historical submission frequency, A is a number greater than one, and T is a threshold value. In other embodiments, R and H may be inputs to some function, the output of which may be compared to a threshold value to determine whether fraud is suspected. If the threshold condition is found 506 to have been met, a flag may be set 508 indicating that the recent submission frequency indicates potential fraud.

The method 500 may include determining 510 a historical return frequency for the user identifier and determining 512 a recent return frequency for the user identifier. Return frequency may be defined as the average number of items returned in a given window (recent or historical) or the average number of transactions of which one or more items purchased in the transaction were returned in the given window.

Return frequency may be defined as an average, e.g. an average of X returns (items or transactions) per unit time within a given window. The return frequency may also take into account a purchase price of a transaction, e.g. an average of items worth Y dollars (as indicated by a purchase price for the items) were returned for the user identifier per unit time within the given window.

The difference between the recent submission frequency and the historical return frequency may be evaluated with respect to a threshold condition. For example the threshold condition may include the following expression being true R−H>T or R>A*T, where R is the recent return frequency, H is the historical return frequency, A is a number greater than one, and T is a threshold value. In other embodiments, R and H may be inputs to some function, the output of which may be compared to a threshold value to determine whether fraud is suspected. If the threshold condition is found 514 to have been met, a flag may be set 516 indicating that the recent return frequency indicates potential fraud.

The method 500 may include determining 518 a historical credit amount for the user identifier and determining 520 a recent credit amount for the user identifier. The recent and historical credit amounts may be defined as the average amount of credits assigned based on a difference between a price paid and third party pricing data in the recent window and historical window, respectively. The credits assigned may be credits assigned according to the method 400 of FIG. 4. The credit amount may be the average credit per transaction, i.e. the total amount of credits in a given window divided by the number of transactions for which evaluation according to the method 400 was performed. Alternatively, the credit amount may be the average amount of credits per unit time, i.e. a total amount of credits assigned within a given window divided by the length of the window. In some embodiments, rather than evaluate the recent credit amount based on the entire recent window, the recent credit amount may be the credit based on a difference in a price paid and third party pricing data for a current transaction according to the method 400, i.e. the transaction with respect to which the method 400 and method 500 are being performed.

The difference between the recent credit amount and the historical credit amount may be evaluated with respect to a threshold condition. For example the threshold condition may include the following expression being true R−H>T or R>A*T, where R is the recent credit amount, H is the historical credit amount, A is a number greater than one, and T is a threshold value. In other embodiments, R and H may be inputs to some function, the output of which may be compared to a threshold value to determine whether fraud is suspected. If the threshold condition is found 522 to have been met, a flag may be set 524 indicating that the recent credit amount indicates potential fraud.

The method 500 may include determining 526 a historical category profile for the user identifier and determining 528 a recent category profile for the user identifier. The historical category profile may reflect the categories, sub-categories, and/or departments of good purchased by a user associated with the user identifier during the historical window. For example, products may be represented by product records that are nodes in a hierarchy in which each product is a node that is a descendent of a category node that is a descendent of another category node and so on up to a department node including a collection of category nodes or a root node from which all category nodes and product record nodes are descendants.

Accordingly, for each item purchased in the window, a counter may be incremented for each category in the product hierarchy of which the product record associated with the each item is a descendent. In this manner, both the categories represented in the purchases and the frequency with which products belonging to that category are purchased are recorded. The collection of counters may be the historical category profile or may be processed or otherwise transformed to obtain the historical category profile.

The recent category profile may be computed in the same manner as the historical category profile with respect to items purchased within the recent window. Alternatively, the recent category profile may be the categories in the product hierarchy represented in the transaction with respect to which the method 500 is being performed. In a like manner, the profile based on a single transaction may indicate for each category represented the number of items of the transaction belonging to the each category.

The difference between the recent category profile and the historical category profile may be evaluated with respect to a threshold condition. For example the cosine ratio of the various counters for the various categories represented in the recent and historical category profiles may be calculated. As known in the art, the cosine ratio of tow vectors increases with similarity of the two vectors. Accordingly, if the cosine ratio is below some threshold, the recent and historical category profiles may be deemed so different as to indicate fraud. If this threshold condition, or some other threshold based on a measure of similarity of the category profiles, is found 530 to have been met, a flag may be set 532 indicating that the differences between the recent and historical category profiles potentially indicate fraud.

The method 500 may include determining 534 a historical shopping schedule for the user identifier and determining 536 a recent transaction schedule for the user identifier. The historical shopping schedule may include determining based on the dates and times of previous transactions for the user identifier, the probability that a transaction will occur at a given time of day or day of the week. For example, for a generic day, regardless of day of the week, a likelihood that a transaction will occur in a plurality of time ranges may be calculated, e.g. the probability that a transaction will occur within a given hour of the day or some other division of the day into periods of finite length. Additionally or alternatively, the probability that a transaction will occur on a given day of the week may be determined based on the days of the week on which prior transactions of the customer have occurred. Additionally or alternatively, the probability that a transaction will occur within a given hour on a given day of the week may be determined based on the time of day and days of the week on which prior transactions of the customer have occurred. Additionally or alternatively, the probability that a transaction will occur on a given day of the month may be determined based on the days of the month on which previous transactions have occurred.

Determining 536 the recent transaction schedule may be performed in the same manner as for the historical transaction schedule with respect to transactions occurring in the recent window. Alternatively the recent transaction schedule may simply be some or all of the day of the month, day of the week, and time of day on which the transaction occurred which is the subject of the method 500.

The difference between the historical shopping schedule and recent shopping schedule may be evaluated with respect to a threshold condition. For example, the historical shopping schedule may be expressed in terms of the probability of a transaction occurring during a given time period in the day, a given day of the week, a given time period of a given day of the week, or a given day of the month. The probabilities of the historical shopping schedule for some or all of the time of day, day of the week, and day of the month on which the transaction that is the subject of the method 500 occurred may be evaluated with respect to one or more thresholds. In particular, where the probability is below a threshold for a transaction to occur at a given time of day, on a given day of the week, at a given time of day of a given day of the week, or a given day of the month, then the threshold condition may be deemed to have been exceeded.

In some embodiments, multiple probabilities may be combined and compared to a threshold. For example, for the day of the week of the transaction that is the subject of the method 500 occurs, a first probability of the transaction occurring on that day of the week may be retrieved from the historical shopping profile. For the time of day of the transaction that is the subject of the method 500 occurs, a second probability of the transaction occurring in a time period including that time of day may be retrieved from the historical shopping profile. For the time of day on which the transaction that is the subject of the method 500 occurs, a second probability of the transaction occurring in a time period including that time of day may be retrieved from the historical shopping profile. For the time of day and day of the week on which the transaction that is the subject of the method 500 occurs, a third probability of the transaction occurring in a time period including that time of day on that day of the week may be retrieved from the historical shopping profile. For the day of the month that the transaction that is the subject of the method 500 occurs, a fourth probability of the transaction occurring on that day of the month may be retrieved from the historical shopping profile.

Some or all of the first, second, third, and fourth probabilities may be combined such as by summing or weighting and summing to obtain a combined measure of the probability of a transaction occurring when the transaction that is the subject of the method 500 occurred. This score may then be compared to a threshold condition. In particular, if the score is below a predetermined threshold then the historical shopping profile may be deemed to indicate that the transaction is unlikely and therefore potentially fraudulent.

If this threshold condition, or some other threshold based on a measure of probability of a transaction occurring, is found 538 to have been met, a flag may be set 540 indicating that the differences between the recent and historical category profiles potentially indicate fraud.

The method 500 may include determining 542 a historical network profile and determining 544 a recent network profile for the user identifier. The historical and recent profiles may be based on attributes of software and devices used by a user when interacting with the server system 102 a. Interactions may include ordering products using an ecommerce site, requesting a determination of credits according to the method 400, browsing an online catalog, or other interactions with a web portal or some other interface. Attributes of software and devices used by the user may include a device type, operating system, browser, internet protocol (IP) address, browser user agent, or other attributes of the user device, software on the user device, or actions taken by the user device with respect to the server system 102 a.

Differences between the historical network profile and recent network profile. If the differences are found 546 to exceed a threshold, a flag may be set 548. The degree of difference may be determined in any manner. For example, values may be specified for any of the parameters specified above. That is, the historical network profile may include <parameter,value> pairs and the recent network profile may include corresponding <parameter, value> pairs. The number of parameters between the two profiles that have different values may be counted. If this count exceeds a threshold, the flag may be set 548. For some parameters, a degree of difference may be measured. For example, an IP address is of the form xxx.xxx.xxx.xxx. Accordingly, a difference between the values of the IP address may be measured, with digits to the left being given greater weight than digits to the right.

The method 500 may include determining 550 a historical average price for the user identifier and determining 552 a recent average price for the user identifier. The recent and historical average price may be defined as the average price of items in transactions for the user identifier for the recent and historical windows, respectively. In some embodiments, rather than evaluate the recent average price based on transactions occurring within the entire recent window, the recent average price may be an average price of items in a current transaction according to the method 400, i.e. the transaction with respect to which the method 400 and method 500 are being performed. Alternatively, the largest price among the prices for the current transaction may be used in the place of the average price for the processing described below.

The difference between the recent average price and the historical average price may be evaluated with respect to a threshold condition. For example the threshold condition may include the following expression being true R−H>T or R>A*T, where R is the recent credit amount, H is the historical credit amount, T is a threshold value, and A is a number greater than one. In other embodiments, R and H may be inputs to some function, the output of which may be compared to a threshold value to determine whether fraud is suspected. If the threshold condition is found 97AA to have been met, a flag may be set 97AB indicating that the recent credit amount indicates potential fraud.

The method 97 may include determining 97AC a historical shopping location for the user identifier and determining 97AD a recent shopping location for the user identifier. The recent and historical shopping location may be defined as the average location of stores at which transactions for the user identifier were conducted in the recent and historical windows, respectively. In particular, locations for each transaction expressed as coordinates may be averaged to determine an average location. Alternatively, the average location may be chosen to be the store at which the most transactions were conducted in the window. Store locations may be stored in the form of a code or identifier included in the transaction record for transactions. In some embodiments, rather than evaluate the recent shopping location based on transactions occurring within the entire recent window, the recent shopping location may be the location at which the current transaction occurred.

The difference between the recent shopping location and the historical shopping location may be evaluated with respect to a threshold condition. For example the threshold condition may include the following expression being true //R−H//>T, where R is the recent shopping location, H is the historical shopping location, and T is a threshold value. In other embodiments, R and H may be inputs to some function, the output of which may be compared to a threshold value to determine whether fraud is suspected. If the threshold condition is found 97AE to have been met, a flag may be set 97AF indicating that the recent credit amount indicates potential fraud.

Other aspects of a transaction may also be evaluated with respect to historical transactions and recent transactions (which may be a single transaction that is the subject of the method 97). For example, items purchased may be targeted to a specific demographic of users. If items purchased in the historical window indicate a first demographic (age, gender, income) and the items in the recent window indicate a different demographic, then the transaction may be flagged as potentially fraudulent.

In some embodiments, payment method used in transactions conducted in the historical and recent windows may be compared. Where the payment method is different between the recent and historical transactions, the transaction may be flagged as potentially fraudulent. For example, if a different credit card number is used in the recent transactions than was used for some or all of the historical transactions. The thresholds used at steps 97C, 97G, 97K, 97O, 97S, 97W, 97AA, 97AC may be different from one another and may be determined based on the attributes of transactions known to be fraudulent. The flags set at steps 97D, 97H, 97L, 97P, 97T, 97X, 97AB, 97AD, or according to some other comparison between historical and recent activity, may each be separate variables. Accordingly, the number of flags set may be evaluated to determine whether to deem a transaction as potentially fraudulent. The various flags may have different weights. For example, each flag may be a variable having a value of 0 or 1 indicating whether the flag is set. The value of the flags may then be multiplied by weights corresponding to each flag and the weighted values may then be summed to generate a score. This score may be compared to another threshold condition to determine if the transaction should be deemed fraudulent. For example, if the score exceeds a threshold value, the transaction may be deemed fraudulent. In some embodiments, flags may have a value other than 0 and 1 that corresponds to an amount by which measured parameters exceeds or falls outside of the threshold condition evaluated at steps 97D, 97H, 97L, 97P, 97T, 97X, 97AB and 97AD.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

1. A system, comprising:
a first database configured to store system usage information of the system, the system usage information being associated with a plurality of customers of a retailer;
a second database configured to store pricing information associated with a plurality of products for a plurality of other retailers;
a search engine module coupled to the second database and being configured to receive a search engine search request, the search engine search request including transaction data associated with one of the customers at the retailer, the transaction data including a price of a product paid by the one of the customers during a transaction at the retailer, the search engine module further configured to perform a search of the second database as a function of the search engine search request and return pricing information of the product associated with at least one of the other retailers;
a credit determination module coupled to the first database and the search engine module and being configured to compare the price paid by the one of the customers and the pricing information of the product associated with at least one of the other retailers, the credit determination module being further configured to award the one of the customers a credit if the comparison of the price paid by the one of the customers and the pricing information of the product associated with at least one of the other retailers meets predefined criteria and to store the search engine search request and any awarded credit in the first database as usage information associated with the one of the customers;
a customer scoring module coupled to the first database and being configured to analyze the usage information of the system associated with the plurality of customers and to establish a customer score for each customer as a function of the credit awarded to the respective customer over a plurality of transactions and respective system usage information stored in the first database; and
a customer ranking module coupled to the first database and being configured to rank the plurality of customers as a function of the respective customer score.

2. A system, as set forth in claim 1, wherein the search engine module being further configured to receive multiple search engine search requests for the one of the customers, each search engine search request being associated with a respective transaction at the retailer, each transaction having at least one other product associated therewith, the search engine module being further configured to perform a search of the second database as a function of the search engine search request and return pricing information associated with the at least one other product of the respective transaction associated with at least one of the other retailers.

3. A system, as set forth in claim 2, wherein the credit determination module is further configured to award a credit to the customer as a function of a price paid by the one of the customers for the at least one other product and the pricing information of the at least one other product associated with the at least one of the other retailers.

4. A system, as set forth in claim 2, including a savings module coupled to the first database and the search engine module and being configured to compare the price paid by the one of the customers and the pricing information of the at least one other product associated with the at least one of the other retailers and to establish a savings amount representing an amount saved by the customer for purchasing the product at the retailer.

5. A system, as set forth in claim 4, wherein the customer scoring module is further configured to establish the customer score as a function of an amount of credit awarded to the respective customer and/or an amount of savings made by the respective customer over a plurality of transactions.

6. A system, as set forth in claim 2, wherein the customer scoring module is further configured to establish the customer score as a function of a number of transactions stored in the first database associated with the one of the customers.

7. A system, as set forth in claim 2, wherein the customer scoring module is further configured to establish the customer score as a function of a number of unique products listed associated with the number of transactions stored in the first database and associated with the one of the customers.

8. A system, as set in claim 2, wherein each transaction is performed over one of plurality of retail channels, wherein the customer scoring module is further configured to established the customer score as a function of the number of retail channels utilized by the one of the customers.

9. A system, as set forth in claim 4, wherein each transaction is performed over one of a plurality of retail channels, wherein the customer scoring module is further configured to establish the customer score as a function of an amount of credit awarded to the respective customer and/or an amount of savings made by the respective customer over a plurality of transactions, a number of transactions stored in the first database associated with the one of the customers, a number of unique products listed associated with the number of transactions stored in the first database and associated with the one of the customers, and a number of retail channels utilized by the one of the customers.

10. A system, as set forth in claim 1, wherein the customer ranking module is configured to establish a ranking of the plurality of customers at different levels.

11. A system, as set forth in claim 10, wherein the different levels include a retail store level, a regional level and a global level.

12. A system, as set forth in claim 1, including a customer point determination module coupled to the first database and being configured to analyze the usage information of the system associated with the plurality of customers and the ranking of the plurality of customers, to responsively establish a number of customer points for each customer, and to store the number of established customer points associated with each customer in the first database.

13. A system, as set forth in claim 12, wherein the customer point determination module is further configured to establish the number of customer points for each customer as a function of a number of times the respective customer has shared usage information of the system over a social network.

14. A system, as set forth in claim 12, wherein the customer point determination module is further configured to establish the number of customer points for each customer as a function of a number of referrals made by the respective customer to other customers.

15. A system, as set forth in claim 12, wherein the customer point determination module is further configured to establish the number of customer points for each customer as a function of a number of orders made by the respective customer at a retail website associated with the retailer.

16. A system, as set forth in claim 15, wherein the customer point determination module is further configured to establish the number of customer points for each customer as a function of a number of different departments associated with the retailer at which the respective customer has purchased product(s).

17. A method, comprising:
storing, in a first database, usage information of the system, the system usage information being associated with a plurality of customers of a retailer;
storing, in a second database, pricing information associated with a plurality of products for a plurality of other retailers;
receiving, at a search engine module, a search engine search request, the search engine search request including transaction data associated with one of the customers at the retailer, the transaction data including a price of a product paid by the one of the customers during a transaction at the retailer;
performing, by the search engine module, a search of the second database as a function of the search engine search request and returning pricing information of the product associated with at least one of the other retailers;
comparing, by a credit determination module, the price paid by the one of the customers and the pricing information of the product associated with at least one of the other retailers;
awarding the one of the customers a credit if the comparison of the price paid by the one of the customers and the pricing information of the product associated with at least one of the other retailers meets predefined criteria and storing the search engine search request and any awarded credit in the first database as usage information associated with the one of the customers;
analyzing, by a customer scoring module coupled to the first database, the usage information of the system associated with the plurality of customers and establishing a customer score for each customer as a function of the credit awarded to the respective customer over a plurality of transactions and respective system usage information stored in the first database; and
ranking, by a customer ranking module, as a function of the respective customer score.

18. A method, as set forth in claim 17, including the steps of:
receiving, by the search engine module, multiple search engine search requests for the one of the customers, each search engine search request being associated with a respective transaction at the retailer, each transaction having at least one other product associated therewith; and,
performing, by the search engine module, a search of the second database as a function of the search engine search request and returning pricing information associated with the at least one other product of the respective transaction associated with at least one of the other retailers.

19. A method, as set forth in claim 18, including the step of awarding, by the credit determination module, a credit to the customer as a function of a price paid by the one of the customers for the at least one other product and the pricing information of the at least one other product associated with the at least one of the other retailers.

20. A method, as set forth in claim 18, including the steps of:
comparing, by a savings module, the price paid by the one of the customers and the pricing information of the at least one other product associated with the at least one of the other retailers; and
establishing a savings amount representing an amount saved by the customer for purchasing the product at the retailer.

21. A method, as set forth in claim 20, including the step of establishing the customer score as a function of an amount of credit awarded to the respective customer and/or an amount of savings made by the respective customer over a plurality of transactions.

22. A method, as set forth in claim 18, including the step of establishing the customer score as a function of a number of transactions stored in the first database associated with the one of the customers.

23. A method, as set forth in claim 18, including the step of establishing the customer score as a function of a number of unique products listed associated with the number of transactions stored in the first database and associated with the one of the customers.

24. A method, as set in claim 18, wherein each transaction is performed over one of a plurality of retail channels, wherein the customer score is established as a function of the number of retail channels utilized by the one of the customers.

25. A method, as set forth in claim 20, wherein each transaction is performed over one of a plurality of retail channels, wherein the customer score is established as a function of an amount of credit awarded to the respective customer and/or an amount of savings made by the respective customer over a plurality of transactions, a number of transactions stored in the first database associated with the one of the customers, a number of unique products listed associated with the number of transactions stored in the first database and associated with the one of the customers, and a number of retail channels utilized by the one of the customers.

26. A method, as set forth in claim 17, wherein the customer ranking includes a ranking of the plurality of customers at different levels.

27. A method, as set forth in claim 26, wherein the different levels include a retail store level, a regional level and a global level.

28. A method, as set forth in claim 17, including the steps of:
analyzing, by a customer point determination module, the usage information of the system associated with the plurality of customers and the ranking of the plurality of customers;
responsively establishing a number of customer points for each customer; and
storing the number of established customer points associated with each customer in the first database.

29. A method, as set forth in claim 28, wherein the number of customer points is established as a function of a number of times the respective customer has shared usage information of the system over a social network.

30. A method, as set forth in claim 28, wherein the number of customer points is established as a function of a number of referrals made by the respective customer to other customers.

31. A method, as set forth in claim 28, wherein the number of customer points is established as a function of a number of orders made by the respective customer at a retail website associated with the retailer.

32. A method, as set forth in claim 27, wherein the number of customer points is established as a function of a number of different departments associated with the retailer at which the respective customer has purchased product(s).

33. One or more non-transitory computer-readable storage media, having computer-executable instructions embodied thereon, wherein when executed by at least one processor, the computer-executable instructions cause the processor to operate as:
a first database configured to store system usage information of the system, the system usage information being associated with a plurality of customers of a retailer;
a second database configured to store pricing information associated with a plurality of products for a plurality of other retailers;
a search engine module coupled to the second database and being configured to receive a search engine search request, the search engine search request including transaction data associated with one of the customers at the retailer, the transaction data including a price of a product paid by the one of the customers during a transaction at the retailer, the search engine module further configured to perform a search of the second database as a function of the search engine search request and return pricing information of the product associated with at least one of the other retailers;
a credit determination module coupled to the first database and the search engine module, and being configured to compare the price paid by the one of the customers and the pricing information of the product associated with at least one of the other retailers, the credit determination module being further configured to award the one of the customers a credit if the comparison of the price paid by the one of the customers and the pricing information of the product associated with at least one of the other retailers meets predefined criteria and to store the search engine search request and any awarded credit in the first database as usage information associated with the one of the customers;
a customer scoring module coupled to the first database and being configured to analyze the usage information of the system associated with the plurality of customers and to establish a customer score for each customer as a function of the credit awarded to the respective customer over a plurality of transactions and respective system usage information stored in the first database; and
a customer ranking module coupled to the first database and being configured to rank the plurality of customers as a function of the respective customer score.

34. A system, comprising:
first database means for storing system usage information of the system, the system usage information being associated with a plurality of customers of a retailer;
second database means for storing pricing information associated with a plurality of products for a plurality of other retailers;
search engine means for receiving a search engine search request, the search engine search request including transaction data associated with one of the customers at the retailer, the transaction data including a price of a product paid by the one of the customers during a transaction at the retailer, the search engine means for performing a search of the second database means as a function of the search engine search request and return pricing information of the product associated with at least one of the other retailers;
credit determination means for comparing the price paid by the one of the customers and the pricing information of the product associated with at least one of the other retailers, the credit determination means for awarding the one of the customers a credit if the comparison of the price paid by the one of the customers and the pricing information of the product associated with at least one of the other retailers meets predefined criteria and for storing the search engine search request and any awarded credit in the first database means as usage information associated with the one of the customers;
customer scoring means for analyzing the usage information of the system associated with the plurality of customers and establishing a customer score for each customer as a function of the credit awarded to the respective customer over a plurality of transactions and respective system usage information stored in the first database; and
customer ranking means for ranking the plurality of customers as a function of the respective customer score.
